(19) United States
(12) Patent Application Publication
(10) Pub. No.: US 2014/0083627 A1
(43) Pub. Date: Mar. 27, 2014

(54) AUTOMATED SPRAY DRIER

(71) Applicant: Velico Medical, Inc., Beverly, MA (US)

(72) Inventors: Abdul Wahid Khan, Murrysville, PA (US); Molly Cronin, Somerville, MA (US); Michael Haley, Marlboro, MA (US); Dennis Brian Hubbard, JR., Lancaster, MA (US); George T. Perivolotis, Littleton, MA (US); John Charles Rosenfelder, New Ipswich, NH (US); Michael John Wilt, Windham, NH (US)

(21) Appl. No.: 13/952,541

(22) Filed: Jul. 26, 2013

Related U.S. Application Data
(60) Provisional application No. 61/856,954, filed on Jul. 22, 2013.
(60) Provisional application No. 61/820,428, filed on May 7, 2013.
(60) Provisional application No. 61/706,759, filed on Sep. 27, 2012.

(51) Int. Cl. B01D 1/18

(52) U.S. Cl. CPC B01D 1/18
USPC 159/4.01

(57) ABSTRACT

A spray drier system is provided for spray drying a liquid sample such as blood plasma. The spray drier system may include a spray drier device and a spray drier assembly. The spray drier device may be configured to receive flows of an aerosolizing gas, a drying gas, and blood plasma from respective sources and couple with the spray drier assembly for transmission of the received aerosolizing gas, drying gas, and plasma to the spray drier assembly. Spray drying of the plasma is performed in the spray drier assembly under the control of the spray drier device.

### RELATED APPLICATION(S)

This application claims the benefit of priority of U.S. Provisional Patent Application No. 61/706,759, filed on Sep. 27, 2012 and entitled, “Automated Spray Drier System,” U.S. Provisional Patent Application No. 61/820,428, filed on May 7, 2013 and entitled, “Functionally Closed System Equivalence For Aerosoling And Drying Gas,” and U.S. Provisional Patent Application No. 61/856,954, filed on Jul. 22, 2013 and entitled “Automated Spray Drier,” the entirety of each of which is hereby incorporated by reference.

### GOVERNMENT SUPPORT

This invention was made with Government support under contract HHSO100201200005C awarded by the Biomedical Advanced Research and Development Authority (BARDA). The Government has certain rights in the invention.

### BACKGROUND

Making up about 55% of the total volume of whole blood, blood plasma is a whole blood component which holds blood cells in suspension. Blood plasma further contains a mixture of over 700 proteins and additional substances that perform functions necessary for bodily health, including clotting, protein storage, and electrolytic balance, amongst others. When extracted from whole blood, blood plasma may be employed to replace bodily fluids, antibodies, and clotting factors. Accordingly, blood plasma is extensively used in medical treatments.

To facilitate storage and transportation of blood plasma until use, plasma is typically preserved by fresh-freezing. Fresh-Frozen blood Plasma (FFP) is obtained through a series of steps involving centrifugation of whole blood to separate plasma and then freezing the collected plasma within about 8 hours of drawing the whole blood. In the United States, the American Association of Blood Banks (AABB) standard for FFP is up to 12 months from the date of preparation when stored at −18° C. or colder. FFP may also be stored for up to 7 years if maintained at −65° C. or colder from preparation until the time at which it used. In Europe, FFP has a shelf life of only 3 months if stored at temperatures between −18° C. to −25° C., and for up to 36 months if stored at colder than −25° C. If thawed, European standards dictate that the plasma must be transfused immediately or stored at 1° C. to 6° C. and transfused within 24 hours. If stored longer than 24 hours, the plasma must be relabeled for other uses or discarded.

Notably, however, FFP must be kept within a temperature-controlled environment throughout its duration of storage to maintain its efficacy, which adds to the cost and difficulty of storage and transport. Furthermore, FFP must be thawed prior to use, resulting in a delay of 30-45 minutes before it may be used after removal from cold storage.

Accordingly, there is a need to develop alternative techniques for storage of plasma.

### SUMMARY

In an embodiment, a spray drier device can be provided for converting a liquid plasma sample to dried plasma powder. The spray drier device includes a liquid sample port for receiving a flow of a liquid sample and a spray drier device dock adapted to couple with a spray drier assembly positioned within the dock. The spray drier device dock includes an aerosolizing gas port for receiving a flow of an aerosolizing gas. In certain embodiments, the aerosolizing gas port may not be co-axial with the dryer gas port.

In an embodiment, the spray drier device can further include a locking mechanism positioned adjacent to the dock and configured to couple with a spray drier assembly positioned within the dock. The spray drier device may additionally include an actuator configured to move the locking mechanism between an engaged and a disengaged position, where the locking mechanism inhibits removal of the spray drier assembly from the dock in the engaged position and where the locking mechanism does not inhibit removal of the spray drier assembly from the dock in the disengaged position.

In an embodiment, the spray drier assembly can include a spray drying head attachable to the aerosolizing gas port and the dryer gas port for receiving the flow of aerosolizing gas and the drying gas. The spray drying head may be further configured to receive the flow of liquid sample, provide an aerosolized flow of liquid sample, and expose the aerosolized flow of liquid sample to the drying gas. The spray drier assembly may additionally include a drying chamber configured to receive the aerosolized flow of liquid sample and the flow of drying gas at a first end, separate the aerosolized flow of liquid sample and the flow of drying gas into a dried powder suspended in humid air, and output the suspended dried powder and humid air at a second end.

In an embodiment, the dock can include the liquid sample port. In other embodiments, the spray drying head may include the liquid sample port.

In an embodiment, the spray drier assembly may further include a collection chamber having a first end and a second end. The first end of the collection chamber may be in fluid communication with the second end of the drying chamber, where the collection chamber is configured to separate the dried powder from humid air. At least a portion of the humid air separated from the dried powder can be exhausted from the collection chamber at the second end of the collection chamber.

In an embodiment, at least one of the flow of drying gas and the flow of humid air is adapted to urge the dried powder from the drying chamber to the collection chamber.

In an embodiment, the collection chamber may be further adapted to remove moisture from the dried powder. The collection chamber may include a desiccant positioned within the collection chamber and adapted to further remove moisture from the liquid sample.

In an embodiment, the spray drier device may include a first one-way valve positioned at about the second end of the collection chamber, the first one-way valve permitting one way flow of the humid air from the collection chamber to the device and inhibiting flow of surrounding air back into the collection chamber. The spray drier assembly may also include a second one-way valve positioned at about the first end of the drying chamber, the second one-way valve permitting flow of the dried powder and humid air from the drying chamber to the collection chamber and inhibiting flow of the dried powder and humid air from the collection chamber to the drying chamber.

In an embodiment, the spray drier device may further include a first one-way valve positioned at about the second end of the collection chamber, the first one-way valve permitting one way flow of the humid air from the collection chamber to the device and inhibiting flow of surrounding air back into the collection chamber. The spray drier device may additionally include a second one-way valve positioned at about the second end of the drying chamber, the second one-way valve permitting flow of the dried powder and humid air from the drying chamber to the collection chamber and inhibiting flow of the dried powder and humid air from the collection chamber to the drying chamber.

In an embodiment, the spray drying head and the drying chamber can be formed from a re-sterilizable material. For example, the collection chamber may be a single use collection chamber. The re-sterilizable material may be selected from the group consisting of metals, metal alloys, stainless steels, and polymers. In an embodiment, the collection chamber may be a single-use collection chamber (e.g., disposable)

In a further embodiment of the spray drier device, the collection chamber may include a vessel containing a rehydration solution and a breakable seal. The seal can inhibit fluid communication between the rehydration solution and the dried plasma in an intact state and can allow fluid communication between the rehydration solution and the dried plasma in a broken state.

In an embodiment, the spray drier device may also include an air expressing device configured to remove at least a portion of the humid air from the collection chamber. The air expressing device may include at least two plates disposed at opposing sides of the collection chamber, where the at least two plates are configured to move between a first position and a second position. The at least two plates do not exert a compressive force upon the collection chamber in the first position and the at least two plates exert a compressive force upon the collection chamber urging at least a portion of the humid air from the collection chamber. In alternative embodiments, the air expressing device may be a vacuum pump in communication with the second end of the collection chamber or with the dryer gas port.

In an embodiment, the spray drying head may further include a drying gas inlet for receiving the flow of drying gas. The drying gas inlet may include an outwardly extending flange.

In a further embodiment, the locking mechanism may engage the flange when the spray drying head is positioned within the dock and the locking mechanism is in the engaged position. The locking mechanism may include a plurality of cams or clamps.

In additional embodiments, the liquid sample is received from a pooled source of liquid sample.

In other embodiments, the flow of drying gas is received from ambient environment via an ambient air inlet in fluid communication with the dryer gas port. The ambient air inlet may include one or more ambient air filters. The ambient air inlet may be in fluid communication with at least one conditioner, the conditioner selected from the group consisting of: dehumidifiers, heaters, and circulation pumps. The ambient air filter may possess combined bacterial filtration efficiency (BFE) of about 10⁶ or better.

In an embodiment, the flow of dryer gas is received from the humid air exhausted from the collection chamber. The humid air exhausted from the collection chamber can pass through at least one of an exhaust filter or at least one conditioner.

In an embodiment, the dried powder can have a mean particle size of less than or equal to 25 μm.

In an embodiment, the spray drier device can further include a housing having a ceiling and two or more walls, where the housing houses (e.g., encloses) the spray dryer assembly. The housing may further include a fan coupled with at least one environmental chamber air filter. The fan and environmental chamber air filter may be configured to produce an air flow across the dock and the spray drier assembly positioned within the dock that is sufficient to provide at least 200 CFU/m³ or less of bacteria in an environment within the housing adjacent to the dock and spray drier assembly.

In an embodiment, the spray drying head can further include at least one filter configured to filter one or more of the aerosolizing gas and the drying gas.

In an embodiment, the spray drier device can further include a spray drier assembly cover. The cover may include a first cover member mounted to the spray drier device and a second cover member hinged to the first cover member and configured to move between an open position and a closed position. In the closed position of the second cover member, the first and second cover members may contain the spray dryer assembly and inhibit deformation of the drying chamber and collection chamber when subjected to internal pressure. The spray drier assembly may conform to the shape of the closed cover when in use such that the cover provides support to the drying chamber and collection chamber when pressurized such that the cover provides support to the drying chamber and collection chamber.

The cover may also include one or more guide features to correctly position the spray drier assembly within the spray drier assembly cover. For example, a plurality of guide features may be positioned on at least one of the first assembly cover member and the second assembly cover member. The plurality of guide features may be adapted to register and position the spray drier assembly within the spray drier assembly cover.

In an embodiment, the spray drier device may include a plurality of port covers for covering the aerosolizing gas port and the dryer gas port and one or more sensors in fluid communication with the plurality of port covers and in communication with the actuator. The one or more sensors may be adapted to detect the presence or absence of the plurality of port covers. The actuator may be adapted to engage when the one or more sensors detects the cover is present and adapted to not engage when the cover is absent and the spray drier assembly is not present in the dock.

In another embodiment, a spray drier device can be provided for converting a liquid plasma sample to dried plasma powder. The spray drier device includes a spray drier device dock. The spray drier device dock device includes a liquid sample port for receiving a flow of a liquid sample, a drying gas port for receiving a flow of drying gas to dry the liquid sample, and an aerosolizer in fluid communication with the liquid sample port, where the aerosolizer is configured to aerosolize the received flow of liquid sample. The spray drier device also includes a locking mechanism positioned adjacent to the dock. The locking mechanism is configured to couple with a spray drier assembly that is positioned within the dock and configured to dry the aerosolized liquid sample. The spray drier device additionally includes an actuator configured to move the locking mechanism between an engaged and a disengaged position, wherein the locking mechanism inhibits removal of the spray drier assembly from the dock in the engaged position and wherein the locking mechanism does not inhibit removal of the spray drier assembly from the dock in the disengaged position.

In a further embodiment, the aerosolizer is configured to aerosolize the liquid sample using ultrasonic waves at a selected wavelength and frequency. The aerosolizer may include one of an ultrasonic atomizing transducer, an ultrasonic humidified transducer, or a piezo ultrasonic atomizer.

In an embodiment, the spray drier device may also include a heater configured to heat the drying gas to a selected temperature prior to receipt at the drying gas port. The heater may irradiate the drying gas to heat the drying gas in the spray drying assembly. The heat source may be configured to heat the drying gas to a selected temperature within the spray drying assembly.

The spray drier device may further include a first heat source adapted to heat the drying gas within the drying chamber and a second heat source adapted to heat the drying gas within the collection chamber.

In an embodiment, the flow of drying gas may travel in a selected flow pathway. The flow of drying gas may urge at least one of the dried sample and humid air to travel along the selected flow pathway.

In an embodiment, the spray drier device may include at least one drying gas filter configured to remove contaminants from the flow of drying gas prior to receipt at the drying gas port.

In a further embodiment, a method of spray drying a liquid sample can be provided for converting the liquid plasma sample to dried plasma powder. The method includes receiving a flow of an aerosolizing gas and a drying gas at a spray drier assembly dock. The method also includes coupling a spray drier assembly with the dock to provide fluid communication between the flows aerosolizing gas and drying gas with respective inlet ports of the spray drier assembly. The method can additionally include receiving, at the spray drier assembly, a flow of liquid sample. The method also includes providing, from a head of the spray drier assembly, an aerosolized flow of liquid sample exposed to the drying gas. The method additionally includes separating, at a drying chamber of the spray drier assembly, the aerosolized flow of liquid sample and drying gas into a dried powder suspended in humid air. The method also includes filtering, at a collection chamber of the spray drier assembly, the dried powder from the humid air.

In an embodiment of the method, receiving a flow of the aerosolizing gas and the drying gas at the spray drier assembly further includes receiving the flow of aerosolizing gas in a manner that is not co-axial with the flow of drying gas.

In an embodiment of the method, filtering the dried powder from the humid air further includes collecting the dried powder within a reservoir of the collection chamber. Filtering the dried powder from the humid air may further include exhausting humid air from the collection chamber.

In an embodiment, the method may further include conditioning one or more of temperature, flow rate, moisture content, and bacterial load of the humid air exhausted from the collection chamber.

In an embodiment, the method may further include re-circulating the humid air exhausted from the collection chamber to the spray drier assembly dock.

In an embodiment, the method may further include filtering at least one of the aerosolizing gas and drying gas prior to receipt at the dock. The amount of bacteria present in the filtered gas may be at least 200 CFU/m³ or less.

In an embodiment of the method, the flows of aerosolizing gas and drying air may be received at respective first rates when receiving the flow of liquid sample at the spray drier assembly. The flows of aerosolizing gas and drying air are received at respective second rates when not receiving the flow of liquid sample at the spray drier assembly. The respective first rates are different than the respective second rates.

In an additional embodiment, a spray drier device is provided for drying a liquid sample. The spray drier device includes a spray drier assembly dock. The spray drier assembly dock may include a plurality of ports for receiving respective flows of an aerosolizing gas and a dryer gas. The spray drier assembly dock may also be configured to couple with a spray drier assembly. The spray drier assembly may further include a spray drying head receiving flow of the aerosolizing gas and the drying gas from the aerosolizing gas port and the dryer gas port and further receiving a flow of liquid sample at a liquid sample port. The spray drying head may be configured to provide an aerosolized flow of liquid sample and expose the aerosolized flow of liquid sample to the drying gas. The spray drier assembly may also include a drying chamber configured to receive the aerosolized flow of liquid sample and drying gas and separate the aerosolized flow of liquid sample and drying gas into a dried powder suspended in humid air. The spray drier assembly may additionally include a collection chamber configured to separate the dried powder from humid air, the collection chamber having an inlet port in fluid communication with the drying chamber and an exhaust port allowing humid air to exit the collection chamber. The spray drier may also include a plurality of sealing mechanisms configured to move between a first position and a second position. The plurality of sealing mechanisms may be distanced from the collection chamber in the first position and, in the second position, engage the collection chamber to form a hermetic seal at about the inlet port and the exhaust port of the collection chamber.

In an embodiment of the spray drier device, the plurality of sealing mechanisms may be further configured to separate the collection chamber from the spray drier assembly in the second position.

In an embodiment, the spray drier device may further a plurality of plates positioned adjacent to collection chamber, the plurality of plates configured to compress the collection chamber and urge the humid air from the collection chamber.

In an embodiment of the spray drier device, the aerosolizing gas port is not co-axial with respect to the dryer gas port.

In an embodiment of the spray drier device, a source of the flow of dryer gas may be ambient environment.

In an embodiment of the spray drier device, a source of the flow of drying gas may be the humid air that exits the collection chamber.

In an embodiment of the spray drier device, the dried powder may possess a mean particle size of between about 0.2 μm and about 25 μm.

In an embodiment, the spray drier device may further include comprising an air flow across the dock and spray drier assembly which provides at least 200 CFU/m³ or less of bacteria in the adjacent environment.

The spray drier device and spray drier assembly so configured possesses a variety of advantages. In one aspect, the dock allows the spray drier assembly to be easily removed from the spray drier device, while maintaining a sterile environment on and around the dock. In this manner, when using single plasma units as the plasma source, spray drier assemblies may be quickly changed out of the spray drier device along with an empty plasma source container (e.g., a single plasma unit)

In another aspect, the spray drier assembly may be formed, at least in part, from materials that may be easily re-sterilized and reused. As a result, only a portion of the spray drier assembly that collects and stores dried plasma may be consumed in a spray drying operation. The remainder of the spray drier assembly may be re-sterilized and combined with another collection chamber for collection and storage of dried plasma. By providing a spray drier assembly which can be reused, in majority part, the cost of spray drying may be reduced.

In a further aspect, areas at and around the spray drier device, spray drier assembly, the dock, and attendant connections may be maintained in a sterile state, facilitating removal and attachment of the spray drier assembly to the spray drier device.

In an additional aspect, the spray drier device may be used, alone or in tandem, with pooled plasma sources, allowing for continuous drying of large batches of plasma, which may facilitate faster processing of plasma and timely storage of the plasma.

In another aspect, the spray drier assembly may include a head configured to direct the flow of drying gas within a drying chamber of the assembly. By directing the flow path of the drying gas, the length of contact between the aerosolized plasma and drying gas may be increased, reducing the time to dry the liquid plasma for a given drying chamber size.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1A is a schematic illustration of an embodiment of a spray drier system of the present disclosure, including a spray drier device and a spray drier assembly;

FIG. 1B is a schematic illustration of a plurality of the spray drier systems of FIG. 1 for use with a pooled liquid source;

FIGS. 2A and 2B are schematic illustrations of a spray drier assembly detailing embodiments of the spray drier assembly of FIG. 1A;

FIG. 2C is a perspective view of an embodiment of the spray drier assembly;

FIG. 2D is a schematic illustration of an embodiment of a collection chamber of the spray drier assembly of FIG. 1A;

FIGS. 3A-3C are views of embodiments of a head of the spray drier assembly of FIG. 1A; (A) front perspective view; (B) rear perspective view; (C) schematic, cut-away view;

FIGS. 4A-4B are schematic illustrations of embodiments of a filter support of the spray drier assembly head; (A) radially extending fins; (B) angled fins;

FIGS. 4C-4D are perspective, three-dimensional views of embodiments of the filter support of FIGS. 4A-4B;

FIGS. 5A-5B are schematic illustrations of embodiments of the spray drier system of FIG. 1A, illustrating gas flow pathways between the spray drier device and spray drier assembly;

FIGS. 6A-6B are perspective views of an embodiment of a dock of the spray drier system of FIG. 1A; (A) front view; (B) rear view;

FIG. 6C is a schematic illustration of an actuator in communication with the dock of FIGS. 6A-6B;

FIGS. 7A-7B are a perspective views of embodiments of the dock of FIGS. 6A-6B with the locking mechanism in the (A) open position and (B) closed position;

FIGS. 8A-8B are perspective views of an embodiment of a cover for the spray drier assembly of the present disclosure; (A) open position; (B) closed position; and

FIG. 9 is a schematic illustration of a sealing device for sealing the collection chamber of FIG. 2D.

### DETAILED DESCRIPTION

Embodiments of the present disclosure are directed to systems and methods for spray drying a liquid sample. In certain embodiments, the liquid sample is plasma obtained from a blood donor. However, it may be understood that embodiments of the disclosed spray drier systems and methods may be employed to spray dry any mixtures of solid particles in a continuous liquid medium, including, but not limited to, colloids, suspensions, and sols.

In general, a spray drier system is provided for spray drying a liquid sample such as blood plasma. In an embodiment, the spray drier system of the present technology includes a spray drier device and a spray drier assembly. The spray drier device is configured, in an aspect, to receive flows of an aerosolizing gas, a drying gas, and a plasma from respective sources and reversibly couple with the spray drier assembly for transmission of the received aerosolizing gas, drying gas, and plasma to the spray drier assembly. Spray drying of the plasma is performed in the spray drier assembly under the control of the spray drier device.

In certain embodiments, the spray drier assembly includes a spray drying head, a drying chamber, and a collection chamber. During spray drying, the flow of blood plasma, aerosolizing gas, and drying gas may be received at the spray drier head. Within the spray drier head, in an embodiment, the blood plasma is aerosolized using the aerosolizing gas to form an aerosolized blood plasma. The aerosolized plasma may be further mixed with the drying gas in the spray drier head and emitted into the drying chamber. In the drying chamber, contact between the aerosolized plasma and the drying gas causes moisture to move from the aerosolized plasma to the drying gas, producing dried plasma and humid drying gas. In this embodiment, the dried plasma and humid drying gas subsequently flow into the collection chamber, where the dried plasma is isolated from the humid drying gas and collected, while the humid drying gas is exhausted from the spray drier assembly into the device for recirculation (e.g., a closed system), or into the outside air, as further described herein (e.g., an open system).

In alternative embodiments, the aerosolizing gas may be omitted and the spray drier assembly head may include an aerosolizer that receives and atomizes the flow of plasma. Examples of the aerosolizer may include, but are not limited to, ultrasonic atomizing transducers, ultrasonic humidified transducers, and piezo-ultrasonic atomizers.

The spray drier device may further include one or more conditioners devices adapted to modify one or more properties of the plasma, aerosolizing gas, and/or drying gas. Such properties may include, but are not limited to, temperature, pressure, moisture content, purity (e.g., bacterial load/contamination), and flow rate. Conditioner examples include, but are not limited to, heaters, pumps, filters, dehumidifiers, humidifiers, regulators, valves, and like.

The spray drier assembly and spray drier device may optionally include a plurality of secondary heaters that, in combination with the drying air, assist in drying the aerosolized plasma. In one embodiment, a heater may be positioned at or near the point of aerosolization or shortly thereafter in the path of the aerosolized plasma (e.g., in the drying chamber). In another embodiment, the secondary heater may be adapted to irradiate the spray drier assembly 104. For example, the secondary heater may be positioned outside the spray drier assembly 104 and energy (e.g., electromagnetic, radio-frequency, radiation, microwaves, etc.) is directed through the wall of the spray drier assembly for heating (e.g., heating the drying chamber 104B and/or heating the collection chamber 104C).

Providing secondary heaters may provide additional benefits beyond just temperature control. For example, by providing secondary heaters for heating of the drying chamber 104B, the temperature of the flow of drying gas 114C entering the spray drier assembly 104 may be reduced. That is to say, the temperature of the flow of drying gas 114C entering the spray drier assembly 104 does not need to be elevated in order to account for heat loss within the spray drier assembly 104. Accordingly, the filter 302 may be rated to operate at a lower temperature, allowing the use of cheaper filter, which reduces the cost of the spray drier assembly 104.

After collecting the dried plasma within the collection chamber, the collection chamber can be separated from the spray drier assembly and hermetically sealed. In this manner, the sealed collection chamber sterilely stores the dried plasma until use. In a certain embodiment, the collection chamber includes a plurality of ports allowing a rehydration solution to be placed in fluid communication with the collection chamber. Flow of the rehydration solution into the collection chamber reconstitutes the plasma for use in treating an individual.

In an embodiment of the present technology, a collection chamber may include a separate second vessel or container for storing/maintaining the rehydration solution. A seal is further present between the dried plasma and the rehydration solution. When reconstitution of the dried plasma is desired, the second vessel is brought into fluid communication with the dried plasma (e.g., the user breaks the seal to allow communication or contact between the rehydration solution and the dried plasma).

In certain embodiments, the spray drier device may further include a dock. The dock, in an embodiment, is configured to receive flows of both the aerosolizing gas and drying gas from their respective sources via a plurality of conduits. In this embodiment, the dock is configured to sterilely engage with the head of the spray drying assembly for transmission of the aerosolizing gas and drying gas from the spray drier device to the spray drier assembly. In certain embodiments, the flow of liquid sample is also received at the dock and transmitted to the spray drier assembly. In other embodiments, the flow of liquid sample is received directly at the spray drier assembly, without passing through the dock.

The spray drier assembly head may further include quick-connect ports for receiving the drying gas and the aerosolizing gas (and optionally, the liquid sample, when the liquid sample is directed to the dock). Beneficially, this confirmation may reduce the number of operations an operator must perform to connect the spray drier assembly to the spray drier device, allowing for more ergonomic and quicker processing of blood, as well as fewer errors. Additionally, by avoiding transmission of the gas (and optionally liquid) flows to the spray drier assembly through the walls of the spray drier assembly body, sterile integrity of the spray drier assembly may be more easily maintained. Furthermore, eliminating multi-piece connections may reduce the complexity and cost of the spray drier assembly.

Embodiments of the dock may also include a locking mechanism configured to move between a closed position and an open position. In the open position, the head of the spray drier assembly may be freely positioned within the dock or removed from the dock. In the closed position, a spray drier assembly head positioned within the dock is prohibited from being removed from the dock by the locking mechanism.

By providing a spray drier assembly that can be removed from the spray drier device, the spray drier assembly can be configured for use multiple times or used a single time. In each case, the spray drier head, spray drying chamber, and collection chamber are each made from materials that are sterile or can be sterilized. In an embodiment, sterilization may be performed through various techniques including, but not limited to, autoclave sterilization, light sterilization, radiation sterilization, heat sterilization, chemical/gas sterilization, pressure sterilization, and a combination thereof. In another embodiment, pieces of the spray dry system or assembly may be formed from, or coated with, materials that resist or minimize bacterial, fungal or viral growth (e.g., materials impregnated with or made from silver, copper, chlorhexidine, antibiotics, and the like).

Reusable components of the spray drier assembly are sterilized prior to each spray drying operation. For example, reusable components may include one or more of the spray drier head and drying chamber. Notably, in certain embodiments, as the collection chamber stores the dried plasma, it may be formed from disposable materials and employed in combination with the reusable components of the spray drier assembly. Each reusable component may be independently formed from materials having relatively high durability in order to withstand repeated sterilization without experiencing damage (e.g., wear). Examples may include, but are not limited to, metals, metal alloys, stainless steels, and the like.

Disposable components of the spray drier assembly 104 are sterilized prior to spray drying operation and discarded after use. For example, disposable components may include one or more of the spray drier head 104A, spray drying chamber 104B, and collection chamber 104C. Accordingly, each disposable component may be independently formed from materials having durability sufficient for sterilization prior to use, without necessarily possessing additional durability to withstand repeated sterilization. Examples may include, but are not limited to, polymers.

The use of a combination of reusable and disposable components within the spray drying assembly may provide efficiency and cost savings. For example, by providing a spray drier assembly having a reusable spray drying head and drying chamber with a single-use, disposable collection chamber, the collection chamber may be decoupled from the remainder of the assembly. Thus, a significant fraction of the spray drier assembly does not require replacement during each use, reducing the spray drying cost.

When handling transfusion products, such as plasma, the transfusion products must be maintained in a functionally closed environment from the time they are collected to the time they are transfused. In other words, collected blood components are not to be exposed to any contaminants during collection, drying, storage, and transfusion. Accordingly, embodiments of the system are further configured to provide a functionally closed environment which provides an environment that is essentially free of contaminants e.g., that contamination is at an acceptable level within the spray drying system, including in the spray drier device, spray drier assembly, or collection chamber of the present technology during spray drying operations.

The phrases “free of contaminants,” “essentially free of contaminants” and “sterile” refer to an environment, device and/or assembly that have a selected bacterial load, selected combined bacterial efficiency (BFE), or any combination thereof. In an embodiment, the bacterial load and BFE may be selected to provide a medically acceptable level of bacteria within the system. In a further non-limiting embodiment, the selected bacterial load may be approximately 1 CFU/m³ or less. In another non-limiting embodiment, the selected BFE may be 10⁶ or greater.

Each of the aerosolizing gas and drying gas within the spray drying assembly is considered sterile and meets these requirements. For example, in certain embodiments, the flows of aerosolizing gas and drying gas are passed through a plurality of filters. In this manner, gas for aerosolizing, drying, or both are introduced to the spray drying assembly essentially free of contaminants. Examples of such filters include HEPA and ULPA filters (see Table 1 below) that achieve the level of bacterial efficiency/bacterial load described herein. In alternative embodiments, other filters known in the art or developed in the future can be used so long as the bacterial efficiency/bacterial load described herein is achieved. Filters can also be layered to achieve the efficiency described above. For example, a single 0.2 micron filter can be used or, alternatively, two or more lower-efficiency filters can be placed in series to achieve the desired level of filtration efficiency.

TABLE 1
Filter Efficiency

| EN1822 | | |
|---|---|---|
| Classification of the Filter | % Clean Air | |
| | HEPA Filters Stopping Particles ≧0.3 μm | |
| H10 | 95% | Clean Air |
| H11 | 98% | Clean Air |
| H12 | 99.99% | Clean Air |
| H13 | 99.997 | Clean Air |
| H14 | 99.999% | Clean Air |
| | ULPA Filters Stopping Particles ≧0.3 μm | |
| U15 | 99.9995% | Clean Air |
| U16 | 99.99995% | Clean Air |
| U17 | 99.999995% | Clean Air |

TABLE 2
ISO 14644-1 Cleanroom Classifications

| | Maximum particles/m³ | | | | | | FED STD 209E |
|---|---|---|---|---|---|---|---|
| Class | ≧0.1 μm | ≧0.2 μm | ≧0.3 μm | ≧0.5 μm | ≧1 μm | ≧5 μm | equivalent |
| ISO 1 | 10 | 2.37 | 1.02 | 0.35 | 0.083 | 0.0029 | |
| ISO 2 | 100 | 23.7 | 10.2 | 3.5 | 0.83 | 0.029 | |
| ISO 3 | 1,000 | 237 | 102 | 35 | 8.3 | 0.29 | Class 1 |
| ISO 4 | 10,000 | 2,370 | 1,020 | 352 | 83 | 2.9 | Class 10 |
| ISO 5 | 100,000 | 23,700 | 10,200 | 3,520 | 832 | 29 | Class 100 |
| ISO 6 | 1.0 × 10⁶ | 237,000 | 102,000 | 35,200 | 8,320 | 293 | Class 1,000 |
| ISO 7 | 1.0 × 10⁷ | 2.37 × 10⁶ | 1,020,000 | 352,000 | 83,200 | 2,930 | Class 10,000 |
| ISO 8 | 1.0 × 10⁸ | 2.37 × 10⁷ | 1.02 × 10⁷ | 3,520,000 | 832,000 | 29,300 | Class 100,000 |
| ISO 9 | 1.0 × 10⁹ | 2.37 × 10⁸ | 1.02 × 10⁸ | 35,200,000 | 8,320,000 | 293,000 | Room air |

TABLE 3
Air Classifications

| | GMP | | | |
|---|---|---|---|---|
| | A | B | C | D |
| ISO 14644-1 | 5 | 5/6 | 7 | 8 |
| FED STD | 100 | 100/1000 | 10,000 | 100,000 |
| 209E | | | | |
| Air Flow | Laminar flow at | Turbulent air | Turbulent air | Turbulent air flow |
| | working area | flow | flow | |
| Colony | 1 | 10 | 100 | 200 |
| Forming Units | | | | |
| (per m³) | | | | |
| Particles per | ≧0.5 μm: 3,500 | ≧0.5 μm: 3,500 | ≧0.5 μm: | ≧0.5 μm: |
| m³ when in | ≧5.0 μm: none | ≧5.0 μm: none | 350,000 | 3,500,000 |
| rest | | | ≧5.0 μm: 2,000 | ≧5.0 μm: 20,000 |

In other embodiments, the spray drier device includes a housing. The housing may include a ceiling and two or more walls for housing the spray drying assembly. For example, the housing may define an enclosed cavity including the dock for receiving the spray drying assembly. A unidirectional flow of filtered air may be directed from a portion of housing to (e.g., a top portion or ceiling positioned above the spray drier assembly) towards areas at and adjacent to the spray drier assembly, the dock, and the connection there between. For example, the housing may include a fan coupled with at least one filter (e.g., an environmental chamber air filter) to provide a laminar air flow incident upon areas at and adjacent to the spray drier assembly, the dock, and the connection there. This laminar air flow may be provided during the spray dry cycle as well as between spray drying cycles (e.g., during the time the spray drying assembly is connected to the dock of the spray drying device).

Beneficially, the housing and airflow may isolate the spray drier assembly from the environment outside the spray drier device. For example, the housing provides a physical barrier that inhibits contaminants from contacting the spray drier assembly. Furthermore, the provided air flow helps to prevent undesired amounts of bacteria, fungi and viron particles from build up on or near the surfaces of the spray drying device and/or the spray drier assembly. For example, this laminar flow of filtered air can be configured to provide an ISO 8 equivalent environment or better, or an environmental bacterial load of approximately 200 CFU/m³ or less. Furthermore, the positive pressure afforded by the unidirectional flow of air inhibits contaminants from entering the clean surroundings of the docking area. Additionally, the housing may provide protection for an operator in the event that a spray drier assembly ruptures under internal pressure during spray drying operations.

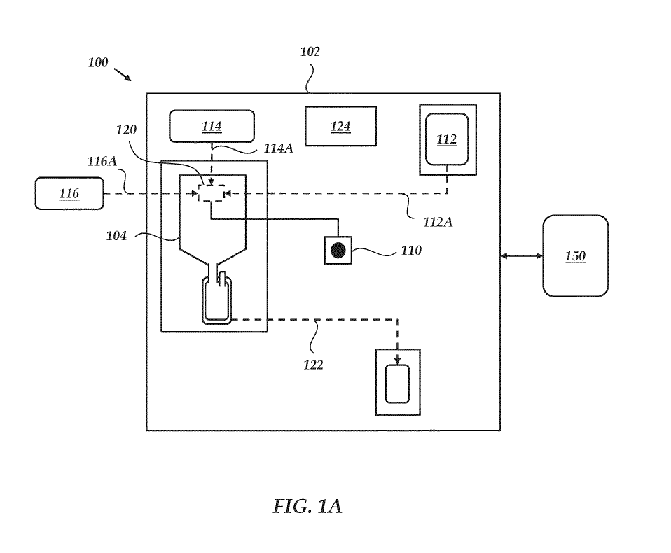

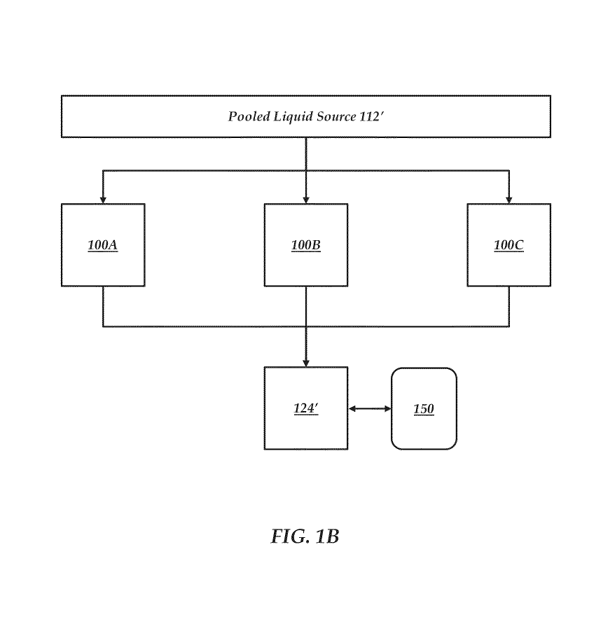

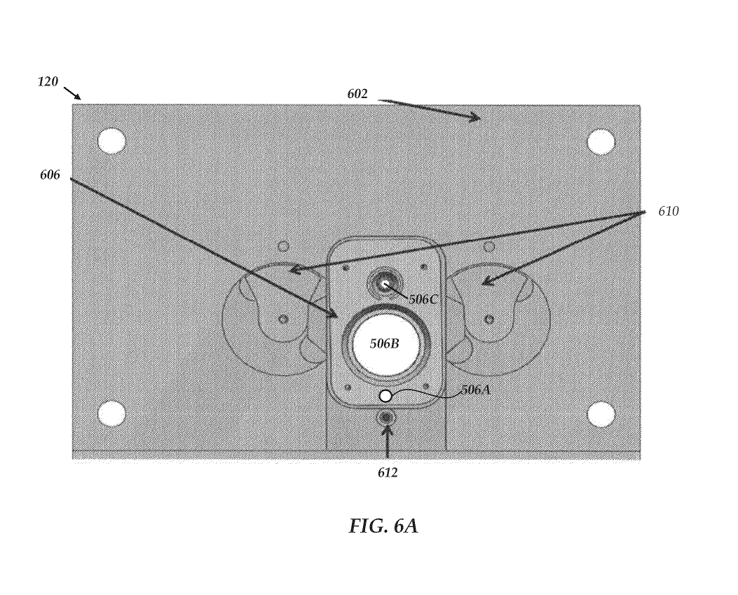

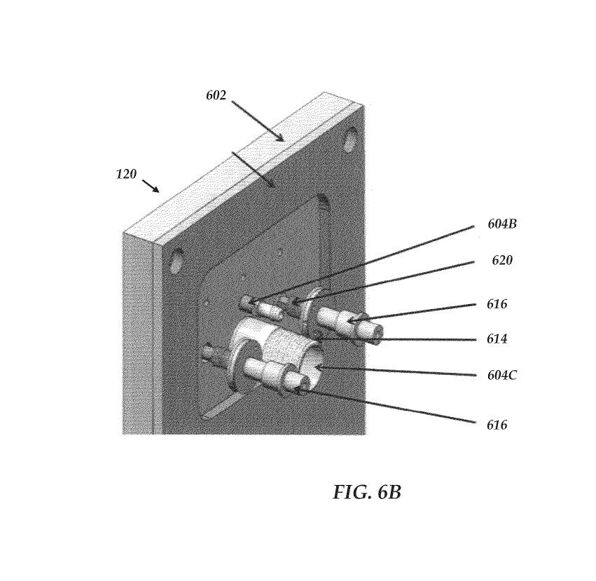

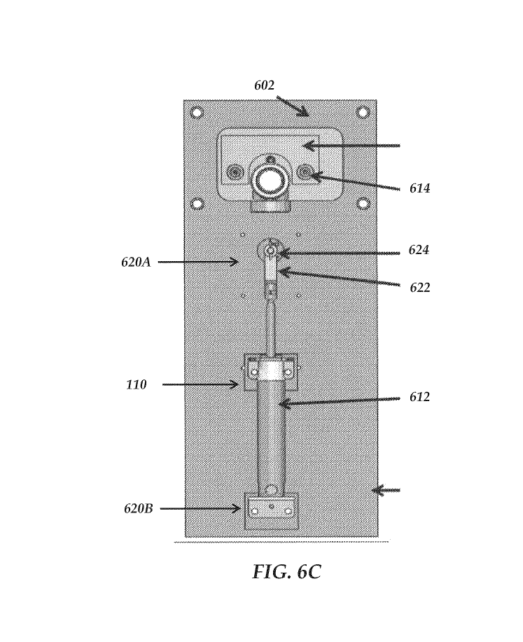

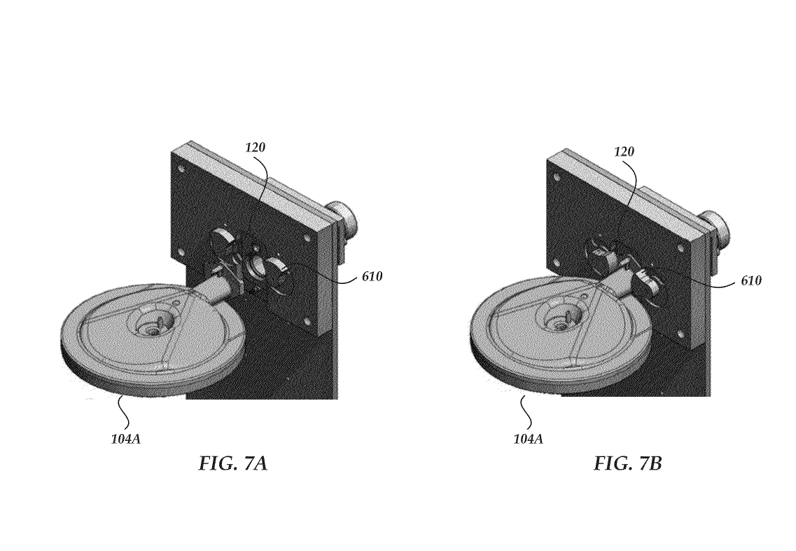

Reference will now be made to FIG. 1A, which schematically illustrates one embodiment of a spray drier system 100. In this embodiment, the system 100 includes a spray drier device 102 configured to receive a spray drier assembly 104 at a dock 120. As discussed in detail below with respect to FIGS. 6A-6B, 7A-7B, the dock 120 can further include a locking mechanism 610 in communication with an actuator 110. The actuator 110 may be employed to cause the locking mechanism 610 to engage or disengage a spray drier assembly 104 positioned within the dock 120. When the locking mechanism 610 is engaged, the spray drier assembly 104 is hermetically and sterilely sealed to the dock 120 for conducting spray drying operations. When the locking mechanism 610 is disengaged, the spray drier assembly 104 may be removed from the dock 120 for disposal or sterilization.

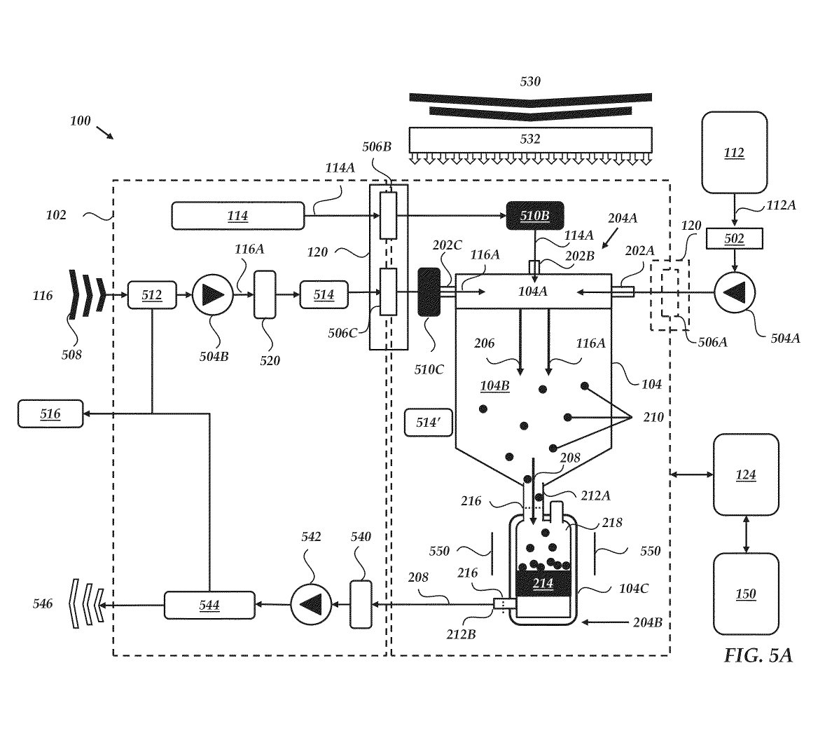

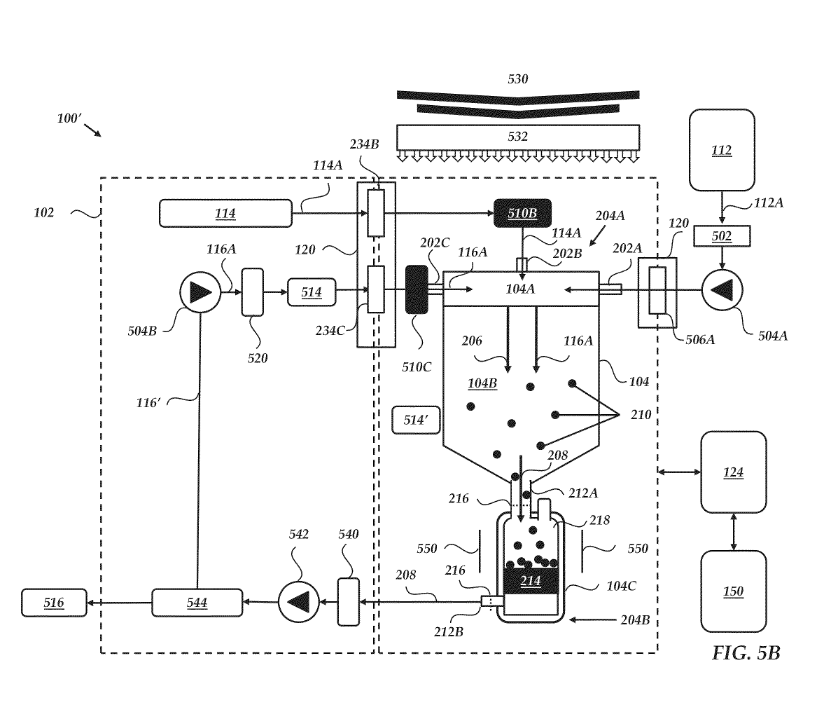

In the embodiment shown in FIG. 1A, a source of plasma 112, a source of aerosolizing gas 114, and a source of drying gas 116 are further in fluid communication with the dock 120. During spray drying operations, flows of the aerosolizing gas 114A and drying gas 116A are drawn through the spray drier device 102 at selected, respective rates, to the dock 120. As discussed in greater detail below with respect to FIGS. 5A-B, the spray drier device 102 may include conditioners (e.g., heaters, pumps, humidifiers/dehumidifiers, etc.) for altering one or more properties of the flow of drying gas 116A. For example, the flow of drying gas 116A may be heated to a temperature between about 50° C. and about 150° C., and urged to move at a flow rate of between about 15 CFM to about 35 CFM. The flow of aerosolizing gas 116A can be urged to move at a flow rate of between about 5 L/min and about 20 L/min and be heated to a temperature between about 15° C. to about 30° C. (e.g., 24′C). The flow of liquid sample 112A may be urged to move at a flow rate of between about 3 ml/min to about 20 ml/min. The flow of the aerosolizing gas 114A, the flow of drying gas 116C, or both direct the flow of the dried sample through at least a portion of the spray drier assembly 104 (e.g., the drying chamber, the collection chamber, or both).

The spray drier assembly 104 shown in FIG. 1A is further connected to the dock 120, where the flows of the aerosolizing gas 114A and dryer gas 116A are transmitted to the spray drier assembly 104 via the dock 120. The flow of liquid sample 112A can enter the spray drier assembly 104 through the dock 120 or bypass the dock 120 and enter a spray drying head of the assembly 104 directly. In the embodiment shown in FIG. 1A, the flow of plasma 112A is further received by the spray drier assembly 104 via the dock 120. In alternative embodiments, the flow of plasma 112A is provided directly to the spray drier assembly 104 without passing through the dock 120. In the spray drier assembly 104, the plasma 112A is aerosolized and dried, producing a dried plasma that may be collected in the collection chamber 104C and stored for future use. Waste water 122 extracted from the plasma during the spray drying process is collected for removal from the system 100 (e.g., in a containment vessel 516).

The spray drier device 102 further includes a spray drier spray drier computer 124. The spray drier spray drier computer 124 is configured to monitor and control a plurality of process parameters of the spray drying operation. The spray drier spray drier computer 124 includes one or more user interfaces. For example, one user interface allows an operator to input data (e.g. operator information, liquid sample information, dried sample information, etc.), command functions (e.g., start, stop, etc.). Another example of a user interface displays status information regarding components of the spray drier device (e.g., operating normally, replace, etc) and/or spray drying process information (e.g., ready, in-process, completed, error, etc.). The spray drier device 102, in an aspect, includes spray drying computer 124 that allows the operator to perform the following operations: 1) to input relevant lot history information, 2) automates the spray drying process, 3) ensures dried product quality by evaluating real-time process parameters.

Spray drying computer 124 communicates with a middleware controller 150 to perform the following operations: 1) receive process and drying data from the spray drier, 2) match process data to donor plasma unit data, 3) store information in a database for record retention, and 4) transmit combined data to the blood center information system for record retention. Middleware controller 150 can operate with one or more spray drying computers 124.

The spray drier device 102 records one or more data associated with a spray drying operation. Examples of these data include, but are not limited to, bibliographic information regarding the liquid plasma which is spray dried (e.g., lot number, collection date, volume, etc.), bibliographic information regarding the spray drying operation (e.g., operator, date of spray drying, serial number of the spray drier assembly 104, volume of dried plasma, etc.), process parameters (e.g., flow rates, temperatures, etc.). Upon completion of a spray drying operation, the spray drier device 102 communicates with the remote computing system to transmit a selected portion or all the collected data to middleware control 150.

For example, spray drying system 100 can be housed in a blood bank facility. The blood bank facility receives regular blood donations for storage. Liquid plasma is separated from whole blood donations, dried using the spray drying system 100, and subsequently stored until use. Middleware controller 150 can be one or more computing devices maintained by the blood bank for tracking stored, dried blood. Providing a spray drying system 100 that relays information regarding dried plasma to local middleware controller 150 that is housed at the blood center allows such information to be conveyed and accessed quickly and accurately at the blood center.

In an alternative embodiment, illustrated in FIG. 1B, a plurality of spray drier systems 100A, 100B, . . . 100N can be used in combination with a pooled plasma source 112′. In general, the pooled plasma source 112′ is a bulk source of blood plasma having a volume larger than one blood unit, as known in the art (e.g., approximately 1 pint or 450 mL). Two or more of the spray drier systems 100A, 100B, . . . 100N can operate concurrently, each drawing blood for spray drying from the pooled plasma source 112′, rather than a smaller, local blood source (e.g., a single unit).

The spray drier systems 100A, 100B, . . . 100N in a pooled environment can operate under the control of a spray drier computer 124′. The spray drier computer 124′ is similar to spray drier computer 124 discussed above, but configured for concurrent control of each of the spray drier systems 100A, 100B, . . . 100N. The spray drier computer 124′ further communicates with a middleware computing device 150, as also discussed above.

In the pooled environment of FIG. 1B, the starting liquid plasma can be pooled to form the pooled source 112′ before drying. The pooled plasma source 112′ can treated for pathogen inactivation e.g., with UV light, a chemical, and the like. The flow of plasma 112A drawn from the pooled plasma source 112′ is dried using one or more spray drying systems 100 of the present technology and collected in a single collection chamber or a plurality of collection chambers. If the pooled plasma is dried for human transfusion, then each collection chamber can be configured with an attached rehydration solution. If the plasma dried from the pooled source 112′ is to be used for fractionation purposes, then it may be collected in a collection chamber configured without the rehydration solution.

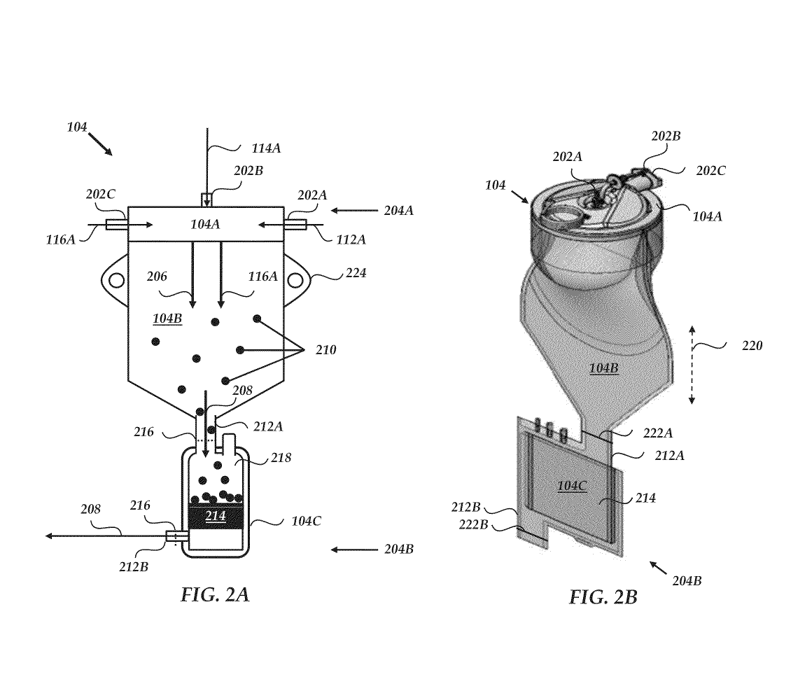

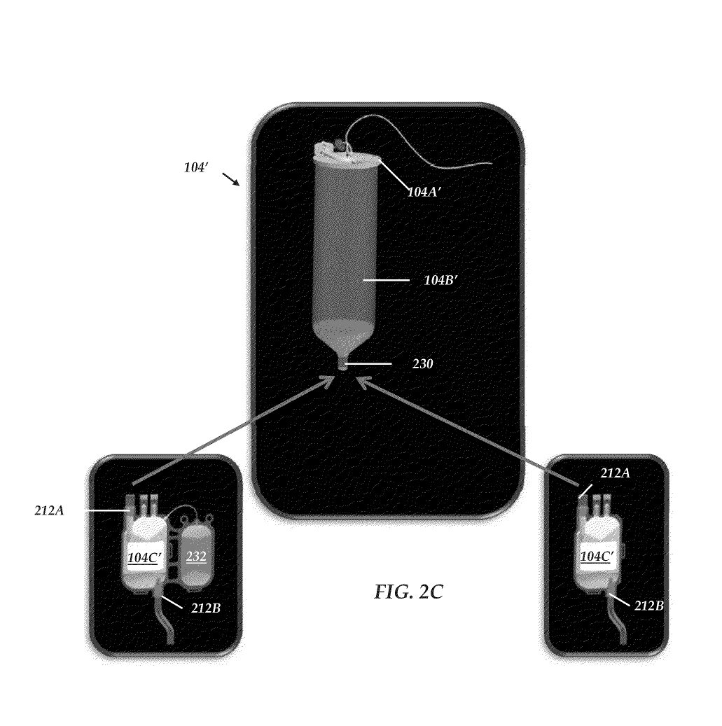

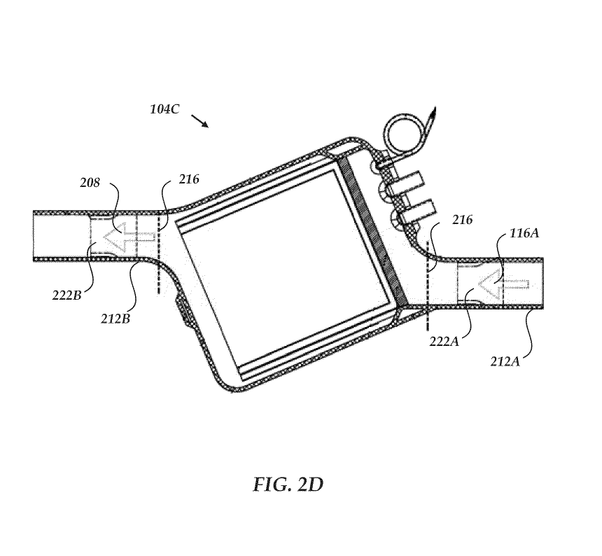

FIGS. 2A and 2B illustrate embodiments of the spray drier assembly 104 in greater detail, in schematic and three-dimensional, perspective views, respectively. The spray drier assembly 104 shown in FIGS. 2A and 2B includes a spray drying head 104A, a drying chamber 104B, and a collection chamber 104C in fluid communication. The spray drying head 104A shown is positioned adjacent to a first end 204A of the spray drier assembly 104. The collection chamber 104C is positioned at about the second end 204B of the spray drier assembly 104. The collection chamber 104B is positioned between the spray drier head 104A and the collection chamber 104C. In certain embodiments, the drying chamber 104B and collection chamber 104C are integrally formed (e.g., from the same material). In alternative embodiments, the drying chamber 104B and collection chamber 104C are separately formed (e.g., from different materials) and joined together.

The plasma is aerosolized to form aerosolized plasma 206 and emitted into the drying chamber 104B, where the flow of the aerosolizing gas 114A and the drying gas 116A direct the aerosolized plasma 206 towards the collection chamber 104C. In an embodiment, the aerosolized plasma 206 is dried to form dried plasma 210 in at least two stages. A first, initial drying stage occurs when the aerosolized plasma 206 is exposed to the flow of drying gas 116A in the drying chamber 104C. A second, subsequent drying stage occurs as the flow of aerosolized plasma 206 is directed into the collection chamber 104C, still in contact with the flow of drying gas 116A. It may be understood, however, that in alternative embodiments, a single drying stage may be employed, either the first or second drying stage.

In a further embodiment, if desired, the secondary drying can be performed in the collection chamber 104C by maintaining the drying gas flow 116A across the dried plasma 210 once it has been collected in the collection chamber 104C. In the case of secondary drying, some of the parameters for flow rates and temperatures of the drying gas can be changed from those specified for primary drying. For example, the flow of drying gas 116A can be heated to a temperature between about 35° C. and about 80° C., and can have a flow rate of between about 10 CFM to about 35 CFM. The flow of aerosolizing gas 114A can have a flow rate of between about 0 L/min and about 20 L/min and a temperature between about 15° C. to about 30° C. (e.g., 24° C.). In another embodiment, heat for the primary or secondary drying can be supplied by a heating device employing energy such as electromagnetic, radiofrequency, radiation, microwave waves that passes through the walls of the drying chamber 104B, the collection chamber 104C, or both.

In yet another embodiment, a desiccant can be placed within the collection chamber 104C to facilitate drying. For example, the desiccant or similar substance can be placed in contact with the dried sample. In another example, the desiccant or similar substance is not placed in contact with the dried plasma but rather in fluid communication with the dried plasma (e.g., on either side of the filter within the collection chamber 104C, in a separate pocket or port). Beneficially, use of desiccant within the collection chamber may allow for further moisture removal from the dried plasma over the duration of storage and increase the shelf-life of the dried plasma.

With further reference to FIGS. 2A and 2B, the spray drier head 104A includes a liquid sample inlet port 202A, an aerosolizing gas inlet port 202B, and a drying gas inlet port 202C for receiving respective flows of liquid sample 112A (e.g., blood plasma), aerosolizing gas 114A, and drying gas 116A. As discussed in greater detail below, in the spray drying head 104A, received flows of aerosolizing gas 114A and blood plasma 112A are mixed to form the aerosolized plasma 206. The aerosolized blood plasma 206 is further exposed to the drying gas 116A simultaneously upon aerosolization, as illustrated in FIG. 2A, or shortly thereafter (e.g., further in the drying chamber 104C and/or even in the collection chamber 104B).

In the drying chamber 104B, the aerosolized liquid plasma 206 and the flow of drying gas 116A remain in contact. Moisture is transferred from the aerosolized liquid plasma 206 to the drying gas 116A through evaporation. As the moisture transfers from the liquid plasma 206 into the flow of drying gas 208, humid gas 208 forms in the drying chamber 104C. The flow of the drying gas 116A directs not only the dried plasma 210 but also the humid gas 208 (e.g., air) to exit the spray drier assembly 104, as further described herein. In certain embodiments, the dried plasma 210 has a mean particle size particle size ranging between about 0.2 μm to about 25 μm. Beneficially, a dried plasma size of less than or equal to about 25 μm may provided improved rehydration performance over larger partials. In further embodiments, the drying chamber 104B can be in thermal communication with a heater 514′ (see, e.g., FIGS. 5A, 5B) configured to heat the flow of drying gas 116A to a selected temperature within the drying chamber 104B.

The humid air 208 and dried plasma 210 are further directed into the collection chamber 104C through an inlet port 212A connecting the collection chamber 104C and the drying chamber 104B. The collection chamber 104C includes filter 214 which allows through-passage of the humid gas 208 and inhibits through-passage of the dried plasma 210. The separation of humid gas 208 and the dried plasma 210 occurs when the humid gas 208 passes through filter 214, which retains the dried plasma 210 and allows the humid gas 208 to pass through the pores of the filter 214. The design of the collection chamber 104C allows the humid gas 208 to be exhausted from the collection chamber 104C through an exhaust port 212B, while the dried plasma 210 is retained in a reservoir 218 of the collection chamber 104C. In an embodiment, as the humid gas 208 and dried plasma 210 pass through the collection chamber 104C, the dried plasma 210 continues to lose moisture during the secondary drying stage.

Beneficially, by exhausting the humid air 208 from the collection chamber, through the filter 214 and exhaust port 212B provides a number of advantages. In one aspect, increased collection efficiency (i.e., less loss of dried plasma 210) may be achieved. In another aspect, the flow of humid air 208 through the collection chamber 104C may help in further removing moisture from dried plasma 210 already collected within the collection chamber 104C and increase the shelf-life of the dried plasma 210.

When desired, the operator can subsequently detach (e.g., cut) the collection chamber 104C from the spray drying assembly 104 and hermetically seal the collection chamber 104C at about the inlet and exhaust ports 212A, 212B (e.g., locations 216). This sealing process allows the collection chamber 104C to subsequently function as storage for the dried plasma 210 until use. Beneficially, by providing a collection chamber 104C for collecting dried plasma 210 that can be sealed and removed from the spray drying assembly 104, the need to further collect and remove the dried plasma 210 from the spray drier assembly 104 is eliminated to a containment and storage vessel. Furthermore, possible contamination of the dried plasma 210 in such a transfer process is avoided.

With reference to FIGS. 2B and 2D, the collection chamber 104C may additionally include a plurality of one-way valves 222A, 222B positioned at about the inlet port 212A and the exhaust port 212B, respectively. The one-way valve 222A may function to permit gas flow from the drying chamber 104B to the collection chamber 104C and inhibit gas flow from the collection chamber 104C to the drying chamber 104B. The one-way valve 222B may function to permit gas flow from the collection chamber 104C while inhibiting gas flow into the collection chamber 104C. While FIG. 2D shows the position of one-way valves 222A, 222B at both the inlet and exhaust ports 212A, 212B of the collection chamber 104C, it may be understood that a single one-way valve may be employed at either the inlet port 212A or the outlet port 212B of the collection chamber 104C.

Referring to FIG. 2C, in certain embodiments, an alternative spray drier assembly 104′ may be provided that is reusable. The spray drier assembly 104′ includes a reusable spray drier head 104A′, a reusable drying chamber 104B′, and a single-use (i.e., disposable) collection chamber 104C′. The drying chamber 104B′ has a distal end 230 to which to one or more disposable collection chambers 104C′ are connected. The disposable collection chambers 104C′ can be attached to the distal end 230 of the reusable drying chamber 104B′ using a removable attachment as known in the art which forms a hermetic seal between the reusable drying chamber 104B′ and disposable collection chamber 104C′. The collection chamber 104C′ can include an exhaust port 212B with one-way valve 222B to prevent the backflow of dried plasma 210. The reusable spray drier head 104′ and reusable spray drying chamber 104B′ may be independently formed from reusable materials including, but not limited to, metals, alloys, stainless steels, and the like.

In alternative embodiments, one or more of the spray drier head 104A, drying chamber 104B, and collection chamber 104C may be formed from disposable materials. Examples of disposable materials may include, but are not limited to, polymers.

As further illustrated in FIG. 2C, the collection chamber 104B′ may optionally have a rehydration solution carrier 232 attached. This embodiment lends itself to use with pooled plasma sources 112′ (e.g., FIG. 1B).

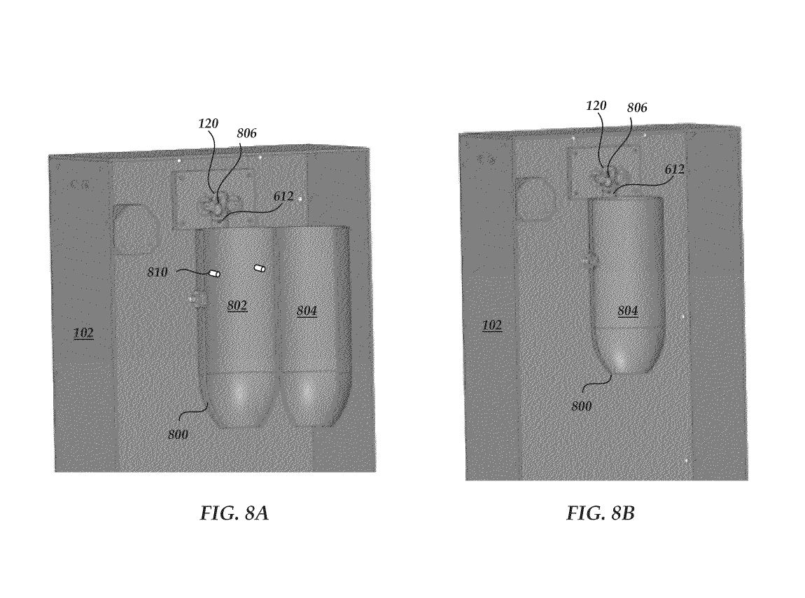

In additional embodiments, the spray drier assembly 104 may further include a plurality of guides 224 that provide a mechanism for placing the spray drier assembly 104 into a correct position to couple with the spray drier device 102. For example, in certain embodiments, the plurality of guides 224 may be positioned on the drying chamber 104B, the collection chamber 104C, or both. The guides 224 may be adapted to mate with corresponding guides positioned on the spray drier device 102 for alignment of the spray drier assembly 104, as discussed in greater detail below with respect to FIG. 8. While the guides 224 are illustrated in FIG. 2A as being positioned on the drying chamber 104B, it may be understood that the guides 224 may be positioned anywhere upon the spray drier assembly 104, as necessary.

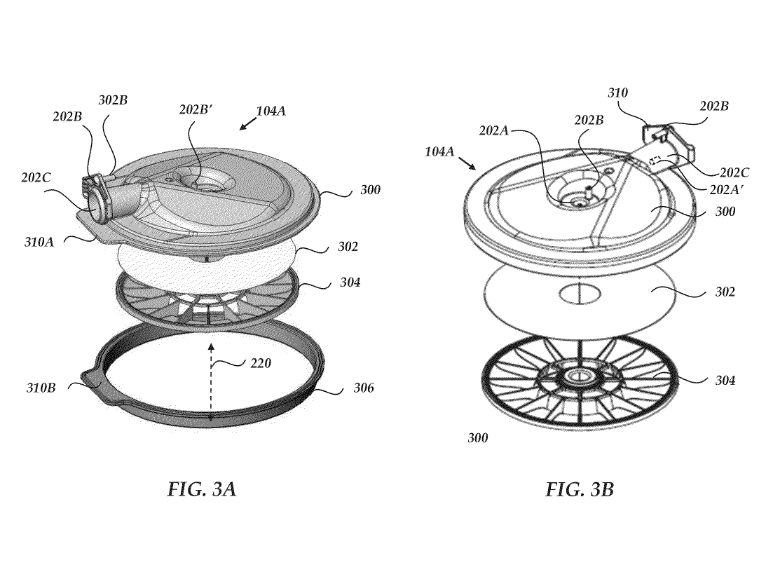

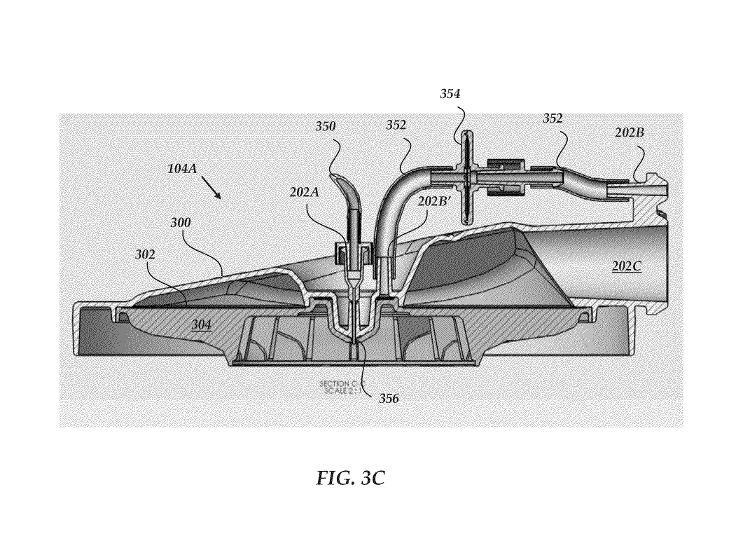

Embodiments of the spray drying head 104A are illustrated in additional detail in FIGS. 3A-3C. FIGS. 3A, 3B illustrate a spray drying head design, in front and rear view, which include a spray head 300, a filter 302, and a filter support 304. The filter 302 may be interposed between the spray head 300 and the filter support 304 for filtering the flow of drying gas 116A. In certain embodiments, the filter 302 may be a 0.2 μm filter. In certain embodiments, the filter 302 may be omitted. For example, in circumstances where the flow of drying gas 116A is determined to be sufficiently clean/sterile for use without filtering by filter 302.

The spray head 300 and filter support 304 may be connected together, for example, by welding, to form a head/filter sub-assembly. An adaptor 306 may be further provided and connected (e.g., welded) to an integrally formed drying chamber 104B and collection chamber 104C at the end of the drying chamber 104B opposite the collection chamber 104C to form a chamber/adaptor sub-assembly. The head/filter sub-assembly and the chamber/adaptor sub-assembly may be connected to each other to form the spray drying assembly 104. In further embodiments, each of the spray head 300 and adaptor 306 may include respective flanges 310A, 310B to facilitate connection of the head/filter sub-assembly and the chamber/adaptor sub-assembly.

FIG. 3C shows a cut-away view of the spray drier head 300 for illustration of different flow pathways within the head 300. A plasma conduit 350 may be provided which places the plasma inlet 202A in fluid communication with the plasma source 112. In certain embodiments, where the flow of plasma 112A does not pass through the dock 120, the plasma conduit 350 may provide a direct connection between the plasma inlet 202A and the plasma source 112. In other embodiments, where the flow of plasma 112A does pass through the dock 120, the plasma conduit 350 may provide a fluid connection between the plasma inlet 202A and the plasma source via a second plasma inlet 202A′ (see, e.g., FIG. 2B) and the dock 120.

An aerosol gas conduit 352 may be further provided places the aerosolizing gas inlet 202B in fluid communication with a second aerosolizing gas inlet 202B′ located at about the center of the head 300. In certain embodiments, a filter 354 may also be placed inline with the conduit 352. The filter 354 may be selected, as appropriate, for the desired degree of filtering. For example, the filter 354 may be a 0.2 μm filter.

The flow of plasma 112A provided via conduit 350 and the flow of aerosolizing gas 114A provided via conduit 352 meet at a nozzle 356 of the spray drier head 300 to produce the aerosolized plasma 206, which is subsequently ejected from the head 300. This aerosolized plasma 206 is further brought into contact with the flow of drying air 116A received at the drying gas inlet 202C and exiting the spray drier head 300.

In alternative embodiments, the flow of aerosolizing gas 114A may be omitted from the system 100. Instead, the nozzle 356 may include an aerosolizer in communication with the plasma inlet 202A and receive the flow of plasma 112A. In one example, the aerosolizer may be adapted to aerosolize the flow of plasma 112A using ultrasonic waves at a selected wavelength and frequency. In another example, the aerosolizer may be an ultrasonic atomizing transducer, an ultrasonic humidified transducer, or a piezo ultrasonic atomizer.

Use of the aerosolizer may provide a number of benefits. In one aspect, use of the aerosolizer may eliminate the need for the flow of aerosolizing gas 114A and filter 354, simplifying the spray drier assembly 104 and reducing its cost. In another aspect, eliminating the flow of aerosolizing gas 114A may remove a possible contamination source from communication with the spray dryer assembly 104.

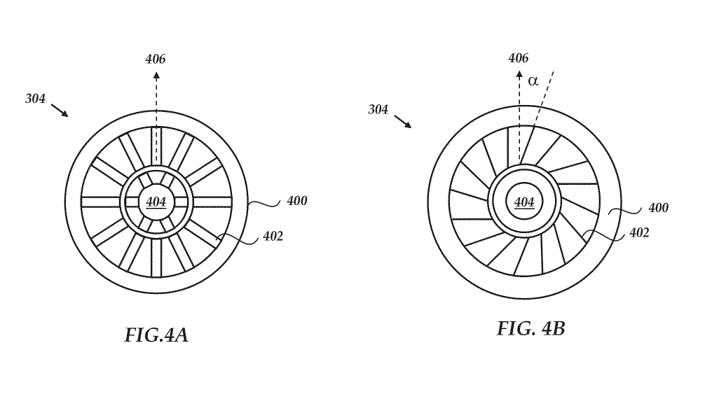

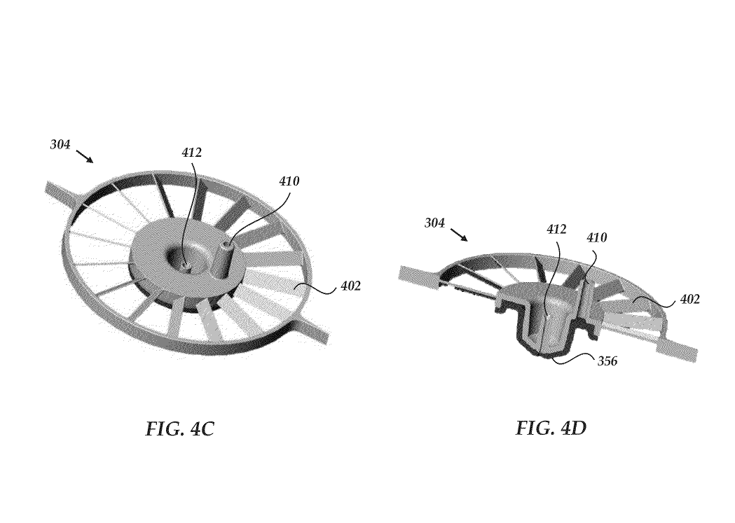

FIGS. 4A and 4B illustrate embodiments of the filter support 304 in a top down view. The filter support 304 includes a frame 400 having a shape configured for attachment with the spray head 300 and a plurality of fins 402. For example, the frame 400 may be formed in a circular configuration for attachment with a circular spray head 300. However, it may be understood that the spray drier head 300 and frame 400 may adopt other shapes, as desired. The fins 402 may also extend outward from a frame center 404 at a selected angle α with respect to a surface normal 406 from the frame center 404. For example, FIG. 4A illustrates one embodiment where angle α is approximately zero and the fins 402 extend radially outward from the frame center 404. FIG. 4B illustrates another embodiment where the angle α is non-zero and the fins are angled circumferentially about the frame center 404. In certain embodiments, angle α may range between about 20 degrees to about 60 degrees, preferably about 45 degrees. In other embodiments, the fins 402 may be set at angular orientations where a surface normal to the plane of the fins 402 lies parallel to the plane of the filter 302, perpendicular to the plane of the filter 302, and angular orientations there between. For example, FIGS. 4C, 4D, illustrate fins 402 oriented at an angle with respect to the plane of the filter 302.

By adjusting the orientation of the fins 302, the filter support 304 may modify the laminar flow of the aerosolized plasma 206 and drying gas 116A passing there through to create a helical flow path. The helical flow path may possess any number of rotations. For example, the aerosolized plasma and drying gas 116A may be directed into a helical swirl having a selected number of revolutions through the length of the drying chamber 104B (e.g., ¼ revolution, 1 revolution, 5 revolutions, 15 revolutions, 25 revolutions, etc.).

With further reference to FIGS. 4C, 4D, additional embodiments of the filter support 304 are illustrated, in perspective and cut-away views, respectively. The filter support 304 may further include a first channel 410 that in fluid communication with the aerosolizing gas inlet port 202B of the spray head 300 and a second channel 412 in fluid communication with the liquid sample inlet port 202A of the spray head 300. The first and second channels 410, 412 direct the flow of blood plasma 212A flow of aerosolizing gas 214A to a nozzle 412, where the flows are mixed to form the aerosolized blood plasma 206 and emitted into the drying chamber 140B.

Producing a helical flow path for the drying gas 116A is believed to provide benefits to the spray drying process. For example, the helical flow path may increase contact of the spray drying gas 116A with the aerosolized liquid sample 206 (e.g., aerosolized blood plasma). This increased time of contact may reduce the path length traveled by the aerosolized liquid sample 206 to achieve a given level of dryness, allowing the length of the drying chamber to be reduced. The increased time of contact may also reduce the time required to achieve a given level of dryness.

With continued reference to FIGS. 3A, 3B, the spray head 300 may include the plasma inlet port 202A, the aerosolizing gas inlet port 202B, and the drying gas inlet port 202C. In certain embodiments, the spray head 300 may further include aerosolizing gas inlet port 202B′ which is in fluid communication with the aerosolizing gas inlet port 202B via conduit 352.

In certain embodiments, the plasma inlet port 202 may be in direct fluid communication with the liquid sample source 112. In this case, the flow of liquid sample 112 does not travel through the dock 120. In additional embodiments, the spray head 300 may also include the plasma inlet port 202A′, which is in fluid communication with the plasma inlet port 202. In this case, the flow does flow through the dock 120.

In certain embodiments, one or more of the liquid sample inlet port 202A, the aerosolizing gas inlet port 202B, and the drying gas inlet port 202C may not be co-axial with respect to each other. The use of non-co-axial ports may, beneficially, reduce the likelihood of leak paths between the respective sources of liquid sample, 112, aerosolizing gas 114 and drying gas 116, as a leak in one flow path is inhibited from flowing into another flow path. Furthermore, so configured, a leak in one flow path is easier to detect, since the flow paths are isolated from one another.

The spray head 300 may further include a plurality of flanges 310 positioned at about the periphery of the drying gas inlet port 202C. As discussed in greater detail below with respect to FIGS. 6A-6B, 7A-7B, the plurality of flanges 310 may be engaged by a locking mechanism when the spray drier head is positioned within the dock 120. With the locking mechanism so engaged, the spray drier assembly 104 may be inhibited from removal from the dock 120.

In an embodiment, the spray drying head 104A and the drying chamber 104B are designed to be used for numerous spray drying operations, sterilized (e.g., autoclaved) prior to each run. For example, in this case, the spray drying head 104A and drying chamber 104B be formed from reusable, re-sterilizable materials, including, but not limited to, metals and alloys (e.g., stainless steel, titanium, aluminum, silver, and the like). Additionally, re-sterilizable material can be made from polymeric materials such as silicon, rubber and plastic. In alternative embodiments, the spray drying head 104A and the drying chamber 104B are designed to be sterilized (e.g., irradiation, or autoclaved) and used in a single spray drying operation. For example, in this case, the spray drying head 104A and drying chamber 104B may be formed from disposable, sterile materials, including, but not limited to, polymers, stainless steel, or silicon.

The discussion will now turn to FIG. 5A, which illustrates an embodiment of the spray drier device 102 in combination with the spray drier assembly 104, detailing flow of the blood plasma 112A, aerosolizing gas 114A, and the drying gas 116A through the spray drier device 102 and assembly 104 to produce dried plasma 210.

The flow of plasma 112A may be routed to the spray drier assembly 104 in the following manner. In an embodiment, the flow of blood plasma 112A originates from the blood plasma source 112. In certain embodiments, the source of blood plasma 112 may be a single unit source (e.g., approximately 1 pint or 450 mL). However, in alternative embodiments, as discussed above with respect to FIG. 1B, the plasma source may be a pooled source 112′. The source of blood plasma 112 is brought into fluid communication with the spray drier device 102 at a sterile connection 502. A pump 504 may urge the flow of blood plasma 112A through the spray drier device 102 and to the spray drier assembly 102 at a selected rate according to the spray drier computer 124.

From the sterile connection 502, the flow of plasma 112A may be provided directly to the spray drier assembly 104 or via the dock 120. In the former case, the spray drier device 102 may include a conduit extending from the sterile dock 502 to liquid sample inlet port 202A of the spray drier assembly 104. In the latter case, the flow of plasma 112 further passes through the plasma inlet 506A of the dock 120 to the plasma inlet port 202A′ of the spray drier assembly 104. From the inlet port 202A′, the flow of plasma 112 further travels to the inlet port 202A of the spray drier assembly 104 (e.g., via conduit 350). In certain embodiments, a filter may be interposed between the inlet port 202A′ and the inlet port 202A.

The flow of aerosolizing gas 114A is routed to the spray drier assembly 104, via the dock 120 of the spray drier device 102, in the following manner. The flow of aerosolizing gas 114A originates from the aerosolizing gas source 114. The aerosolizing gas may include, but is not limited to, compressed air, or an inert gas (e.g., nitrogen, carbon dioxide). The source of aerosolizing gas 114 is brought into fluid communication with the spray drier device 102 at an aerosolizing gas inlet 506B of the dock 120. The flow of aerosolizing gas 114A may be subsequently routed from the dock 120 to the aerosolizing gas inlet port 202B of the spray drier assembly 104.

The flow of drying gas 116A is routed to the spray drier assembly 104, via the dock 120 of the spray drier device 102, in the following manner. The flow of drying gas 116A originates from the drying gas source 116. The drying gas source 116 may be ambient environment (e.g., air). Further examples of drying gas source 116 include compressed air, and inert gases (e.g., nitrogen, carbon dioxide, etc.). A drying gas intake 508 may receive the flow of drying gas 116A from the drying gas source 116. The flow of drying gas 116A may be further routed to a drying gas inlet 506C of the dock 120 via one or more drying gas conduits. The flow of drying gas 116A may be subsequently routed from the dock 120 to the drying gas inlet port 202C of the spray drier assembly 104. A pump 504B may be used to urge the flow of drying gas 116A from the drying gas source 116 to the drying gas inlet 506C of the dock 120 at a selected rate according to the spray drier computer 124.

In certain embodiments, a plurality of conditioners may be interposed between the drying gas source 116 and the dock 120. The conditioners may be configured to adjust one or more of the physical parameters of the drying gas, including, but not limited to, temperature, flow rate, and humidity. For example, the plurality of conditioners may include one or more of pump 504B, a heater 514 configured to heat the flow of drying gas 116A to a selected temperature, and a humidifier/dehumidifier 512 configured to add or remove water from the flow of drying gas 116A to achieve a desired humidity therein. Types of dehumidifiers include cold plate dehumidifiers, membrane dehumidifiers, mechanical separation dehumidifiers and the like. Water extracted from dehumidification may be removed from the spray drier device 102 to containment vessel 516 for disposal.

The discussion will now be directed to embodiments of the disclosure that provide the system 100 with a functionally closed environment for inhibiting contaminants from entering the spray drier device 102 and spray drier assembly 104. With respect to the flow of plasma 112A, the sterile connection 502 maintains the closed environment between the plasma source 112 and the dock 120. With respect to the flow of the aerosolizing gas 114A, a plurality of filters 510B may be interposed between the aerosolizing gas source 114 and the dock 120 to maintain the closed environment between the aerosolizing gas source 114 and the dock 120.

With respect to the drying gas 116A, a plurality of filters 510C and 520 may be may be interposed between the drying gas source 116 and the dock 120 to maintain the closed environment between the drying gas source 116 and the dock 120. In certain embodiments, the plurality of filters 510B, 510C can be configured to provide a combined BFE of equal or greater than 10⁶. In alternative embodiments, a separate filter can also be employed between the aerosolizing gas source 114 and the dock 120. Beneficially, the plurality of filters 510C, 520 may provide that the flow of drying gas 116A received at the dock 120 is sufficiently cleaned from its initial state in the environment (e.g., drying gas source 116) to produce transfusion grade dried plasma. Furthermore, the other conditioners (e.g., humidifier/dehumidifier 512, pump 504B, heater 514) may allow the spray drier device 102 to pre-treat the filtered air, isolating the spray drier device 102 from environmental conditions, and allowing the spray drier device 102 to operate in a variety of environments.

The manner in which the spray drier system 100 maintains the closed environment between the dock 120 and the spray drier assembly 102 will now be discussed. In one aspect, the spray drier assembly 104 may be provided for use with the spray drier device 102 in a sterile state. In another aspect, the dock 120 may be aseptically cleaned prior to receiving the spray drier assembly 104. In a further aspect, the spray drier assembly 104 and dock 120 may be directly connected, with no intermediate conduits.

While the connection between the spray drier assembly 104 and the dock 120 is an aseptic connection, the spray drier device 102 further includes environmental controls to reduce the likelihood of environmental or bacterial contamination between the spray drier assembly 104 and the spray drier device 102 at the dock 120. For example, environmental controls can be provided to produce an environment at and around the spray drier device 104 and dock 120 with a bacterial load of about 200 CFU/m³ or less. With continued reference to FIG. 5A, the environmental controls may include a fan that provides a unidirectional airflow 530, directed through an environmental chamber filter 532, towards the connection between the spray drier assembly 104 and the dock 120. The environmental chamber filter 532 may possesses a high efficiency particulate air (HEPA) efficiency of at least 99.99%. In this manner, a clean environment is provided about the connection between the spray drier assembly 104 and the dock 120. Furthermore, the unidirectional airflow 530 produces a positive pressure in areas outside of the connection between the spray drier assembly 104 and the dock 120 that inhibits contaminants from entering areas at or adjacent to this connection. Furthermore, by increasing the HEPA filtration efficiency, the environmental load around the connection between the spray drier assembly 104 and the dock 120 can be further reduced.

In order to further reduce the likelihood of contamination at the connection between the spray drier assembly 104 and the dock 120, additional processes may be performed. In one process, the flow rates of the aerosolizing gas 114A and the drying gas 116A may be varied between idle and operating states of the system 100. For example, when the system 100 is idle (e.g., the flow of plasma 112A is not provided to the spray drier assembly 104), the flow of aerosolizing gas 114A and the drying gas 116A may provided at a reduced flow rate as compared to when the system 100 is operating (e.g., the flow of plasma 112A is provided to the spray drier assembly 104). In this manner, the collection of bacteria in the gas lines and around the spray drier assembly 104 may be further minimized. In another process, leak testing of the connection between the spray drier assembly 104 and the dock 120, as well as the spray drier assembly 104 itself, may be performed prior to the start of spray drying operations to ensure no leaks are present.

As spray drying operations are being performed, the flow of drying gas 116A moves through the spray drying assembly 104, initially as drying gas 116A, then later as humid drying gas 208, as moisture is transferred from the flow of plasma 112A to the drying gas 116A. As illustrated in FIG. 5A, the humid drying gas 208 is separated from the dried plasma 210 in the collection chamber 104C by the filter 214 and exits the collection chamber 104 through the exhaust port 212B. The humid drying gas 208 may be passed through a filter 540 and a plurality of conditioners 544 which return the humid drying air 208 to a state having reduced humidity and contaminants. For example, contaminants may enter the humid drying air 208 in the event that the spray drier assembly 104 is compromised. In this manner, the humid drying air 208 is of a quality suitable for venting to environment 546. In an embodiment, the plurality of conditioners 544 includes a dehumidifier which transmits waste water to the containment vessel 516. Accordingly, the humidity of the drying air 208 may be reduced such that moisture in this exhausted air does not over-saturate the environment 546 surrounding the spray drier device 102.

The discussion will now turn to venting and sealing of the collection chamber 104C. Upon completion of the spray drying process, a significant amount of humid drying gas 208 remains within the collection chamber 104C. If the majority of the humid drying gas 208 is not removed from the collection chamber 104C prior to sealing, the collection chamber 104C occupies a relatively large volume, compared to a deflated state, with an increased likelihood of rupture due to internal pressure or puncture. Accordingly, it is desirable to purge the humid drying gas 208 from the collection chamber 104C prior to sealing using a purging mechanism.

In one embodiment, the purging mechanism may be a pump 542, configured to operate as a vacuum pump. For example, the collection chamber 104C may be initially sealed at about the inlet port 212A. The humid drying gas 208 within the collection chamber 104C may be expelled to atmosphere 546 by the vacuum generated by the pump 542. Owing to the one-way valve 222B positioned within the exhaust port 212B, the humid drying gas 208 is inhibited from re-entering the collection chamber 104C via the exhaust port 212B once expelled. After removing the desired amount of humid drying gas 208 from the collection chamber 104C, the collection chamber 104C may be sealed at about the exhaust port 212B.

In another embodiment, the purging mechanism may include at least two plates 550 configured to compress the collection chamber 104C. The at least two plates 550 may be disposed at opposing sides of the collection chamber 104C and configured to move between a first position and a second position. In the first position, the at least two plates 550 do not exert a compressive force upon the collection chamber 104C. In the second position, the at least two plates 550 are moved towards one another so as to exert a compressive force upon the collection chamber 104C that urges at least a portion of the humid drying air 208 from the collection chamber 104C.

When employing the plurality of plates 550 to express humid drying gas 208 from the collection chamber 104C, the collection chamber 104C may be initially sealed at about the exhaust port 212B. Subsequently, the humid drying gas 208 within the collection chamber 104C may be expelled to the drying chamber 104B by the mechanical force of the plurality of plates 550. Owing to the one-way valve 222A positioned within the inlet port 212B, the humid drying gas 208 is inhibited from re-entering the collection chamber 104C via the inlet port 212A once expelled. After removing the desired amount of humid drying gas 208 from the collection chamber 104C, the collection chamber may be sealed at about the inlet port 212A.

FIG. 5B illustrates an alternative embodiment of the system 100′ in which humid drying gas 208 expelled from the collection chamber 104C is filtered, conditioned, and recycled for use as a drying gas source 116′. For example, the humid drying gas 208, after being expelled from the collection chamber 104C, may be passed through the filter 540 and the plurality of conditioners 544 as discussed above with respect to FIG. 5A. The reconditioned drying gas exiting the plurality of conditioners 544 is thereby restored to a sterile, less humid state suitable for further use as drying gas source 116′. This drying gas source 116′ is provided in fluid communication with pump 504B. In other respects, the system 100′ operates in the manner discussed above with respect to system 100.

The systems 100, 100′ of FIGS. 5A, 5B each have respective advantages. For example, with respect to system 100, in the event filter 304 fails, the likelihood of cross-contamination between the spray drier assembly 104 and the flow of drying gas 116A/humid drying air 208 may be reduced by exhausting the humid drying air 208 from the system 100. In another example, with respect to system 100′, the flow of drying gas 116A is isolated from the environment surrounding the spray drier system 100′, simplifying the complexity of the system 100′ Furthermore, conditioning of the flow of drying gas 116A (e.g., temperature, flow rate, humidity, etc.) may be reduced or eliminated, improving the efficiency of system 100′.

The discussion will now turn to embodiments of the dock 120 and coupling of the dock 120 with the spray drier assembly 104. FIGS. 6A, 6B illustrate front and rear views of the dock 120, respectively. The front of the dock 120 is configured to receive the spray head 300 of the spray drier assembly 104 and may include a backplate 602 upon which are mounted a plurality of input ports 506B, and 506C. The input port 506B may be configured to receive the aerosolizing gas inlet port 202B for fluid communication between the aerosolizing gas source 114 and the dock 120. The input port 506B may also be configured to receive the drying gas inlet port 202C for fluid communication between the drying gas source 116 and the dock 120.

The input ports 604B, 604C may further extend through the dock 120 from the front side to the rear side. On the rear of the dock 120, the input ports 604B, 604C are configured to mate with the inlet ports 202B, 202C, respectively, to receive the flows of aerosolizing gas 114A and drying gas 116A.

A locking mechanism 610 in communication with an actuator 612 may be further positioned adjacent to the ports 604B, 604C. In general, the locking mechanism 610 may be reversibly moved between a disengaged position, where the locking mechanism 610 allows the spray drier assembly 104 to be freely added or removed from the dock 120, and an engaged position, where the locking mechanism 610 inhibits the spray drier assembly 104 from being removed from the dock 120.

For example, the locking mechanism 610 may include a plurality of cams in communication with a first plurality of pulleys 614 mounted on rods 616. The actuator 612 may include linear actuator (e.g., a piston) having a first end 620A and a second end 620B. The first end 620A of the actuator 612 may include a clevis rod end 622 in communication with a second pulley 624. The second end 620B of the actuator 612 may be in communication with a mechanism (e.g., a foot pedal or button, 110) which urges the clevis rod end 622 to extend (e.g., movement upwards) or retract (e.g., movement downward) when depressed and released, respectively.

When the mechanism 110 is depressed, the linear actuator may move upwards, causing the clevis rod end 622 to rotate the second pulley 624 in a first direction. The second pulley 624 may be in further communication with the first plurality of pulleys 614, where rotation of the second pulley 624 in the first direction may cause the plurality of cams to rotate away from the input ports 506B, 506C and adopt the disengaged position (see, e.g., FIG. 7A). In this disengaged position, the aerosolizing gas inlet port 202B′ and drying gas inlet port 202C of the spray drier assembly 104 are in fluid communication with the aerosolizing gas port 506B and the drying gas port 506C of the dock 120. The flanges 310 of the spray head 300 may be further positioned adjacent to the disengaged cams.

When the mechanism 110 is released, the linear actuator may move downwards, causing the clevis rod end 622 to rotate the second pulley 624 in a second direction, opposite the first direction. Rotation of the second pulley 624 in the second direction may cause the plurality of cams to rotate towards the input ports 506B, 506C and adopt the engaged position (see, e.g., FIG. 7B). In this engaged position, the aerosolizing gas inlet port 202B′ and drying gas inlet port 202C of the spray drier assembly 104 remain received by the aerosolizing gas port 506B and the drying gas port 506C of the dock 120. The flanges 310 of the spray head 300 are further covered by the cams in the engaged position. As a result, the spray head 300, and therefore the spray drier assembly 104, is inhibited from being removed from the dock 120 when the locking mechanism 610 is in the engaged position.

The discussion will now turn to FIGS. 8A, 8B, which illustrate embodiments of a cover 800 for the spray drying assembly 104. The cover 800 may be configured to contain at least a portion of the drying chamber 104B, collection chamber 104C, or both.

The cover 800 may include a first cover member 802 and a second cover member 804 coupled to one another. For example, the first and second cover members 802, 804 is formed in a clamshell design configured to move between an open position and a closed position with a hinge. As shown in FIG. 8A, cover 800 is mounted to the frame to the spray drier device 102. In the open position, the cover 800 is configured to receive the drying chamber 104B and attached collection chamber 104C of the spray drier assembly 104. The cover 800 can be adapted for mechanical removal and replacement so as to limit contamination of the spray drying assembly 104 and/or spray drying dock 120.

The cover 800 may be further dimensioned to contain the drying chamber 104B and collection chamber 104C in the closed position. For example, the cover may contain a volume smaller than the maximum inflation volume of the drying chamber 104B and collection chamber 104C. So dimensioned, when the drying chamber 104B and collection chamber 104C are inflated under pressure of the flow of drying gas 116A during spray drying operations, the exterior surface of the drying chamber 104B and collection chamber 104C may contact the inner surfaces of the cover 800. As a result, the cover 800 provides support to the drying chamber 104B and collection chamber 104C when inflated under internal pressure and inhibits undesired deformation and/or rupture of the drying chamber 104B or collection chamber 104C.

Beneficially, the use of the cover 800 as an external support for the drying chamber 104B and/or the collection chamber 104B may reduce the likelihood of rupture of these components. For example, with the cover 800 in place, deformation of the drying chamber 104B and/or collection chamber 104C due to internal pressure, creep (i.e., time dependent deformation at elevated temperature under load, such as the internal pressure), and the like, which may lead to rupture, can be inhibited.

Also, by allowing the drying chamber 104B and/or the drying chamber 104C to be inflated, under internal pressure, to conform to the shape of the cover may provide further benefits. For example, creases or pleats, which might trap plasma or otherwise alter the drying process, may be reduced or eliminated.

Furthermore, this configuration may also allow safe use of drying chambers 104B and/or collection chambers 104C fabricated from materials that are thinner than would otherwise be prudent. That is to say, the support provided by the cover 800 allows thinner (i.e., weaker) materials to be safely employed in fabrication of the drying chamber 104B and/or collection chamber 104C. Cost savings may also be realized by use of a thinner materials in the components of the spray drier assembly 104, lowering the cost of the assembly 104.

The cover 800 may further include a plurality of guides 810. The guides 810 may be adapted to mate with the plurality of guides 224 of the spray drier assembly 104 for proper alignment of the spray drier assembly 104 with the spray drier device 102 (e.g., positioning of the drying chamber 104C and the spray drying head 104A). For example, the plurality of guides 224 may be configured as apertures and the plurality of guides 810 may be configured as posts. Beneficially, by providing correct alignment of the spray drier assembly 104 with the spray drier device 102, guides 224 and 810 may reduce the likelihood of misalignment, which can lead to spray of the flow of plasma 112 on the walls of the drying chamber 104C

The dock 120 may further include a plurality port covers 806 (see FIGS. 8A, 8B) for covering the aerosolizing gas port 506B and the dryer gas port 506C when the spray drier assembly 104 is not positioned in the dock 120. Optionally, the plurality of port covers 806 may further cover the plasma port 506A of the dock 120, when present. In certain embodiments, the plurality of port covers 806 can be pierceable, frangible, or mechanically removed by the dryer dock so as to limit contamination of the spray drying assembly 104 and/or 120.

One or more sensors 612 may be further provided in communication with the plurality of port covers 806 and in communication with the actuator. The sensors 612 may be adapted to detect the presence or absence of the plurality of port covers 806. The sensors 612 can be mechanical, optical, magnetic, or electrical. Examples include, but are not limited to, optical sensors coupled with software/electrical disconnects, mechanical interlocks, limit switches, and the like.

In operation of the spray drier system 100, the plurality of sensors 612 may detect if any of the plurality of port covers 806 has been removed or compromised when the locking mechanism 610 is disengaged (e.g., when the spray drier assembly 104 is not present in the dock 120). Should the plurality of sensors 612 detect that one or more of the port covers 806 has been removed or compromised when the locking mechanism 610 is disengaged, the spray drier device 102 may not allow the spray drying process to be performed. In one example, the locking mechanism 610 may not be allowed to engage when the spray drier assembly 104 is placed in the dock 120. In another example, the computing device 124 may not allow an operator of the system 100 to enter a command to start spray drying operations. Alternatively, should the plurality of sensors 612 detect that the plurality of port covers 806 have remained in place and uncompromised when the locking mechanism 610 is disengaged, the spray drier device 102 may signal the operator that the spray drier assembly 102 may be coupled with the dock 120 and the plurality of port covers 806 may be removed. In certain embodiments, removal/puncture of the plurality of port covers 806 may be performed as an automated procedure by the spray drier device 102.

Beneficially, in this manner, the conduits conveying flows of the aerosolizing gas 114A, drying gas 116A, and, optionally, the plasma 112A from their respective sources may be kept free of contamination via the input ports 506A, 506B, 506C on the dock. This, in turn, may inhibit contaminants from entering the spray drier assembly 104.

In an alternate embodiment, the mechanism 110 can be replaced with a second sensor for sensing that determines proximity and/or engagement of the flange 310 of the spray drier assembly 104. As described above, the second sensor can also be mechanical, optical, magnetic, or electrical. The connection between the spray drier assembly 104 and the dock 120 is otherwise as described herein.

The cover 800 can further include alignment mechanism to allow proper positioning of the spray drier assembly within the spray drier assembly cover. In an embodiment, the alignment mechanism is mechanical. Examples of such alignment mechanisms can include complimentary slots and tabs, pins and bosses, and the like.

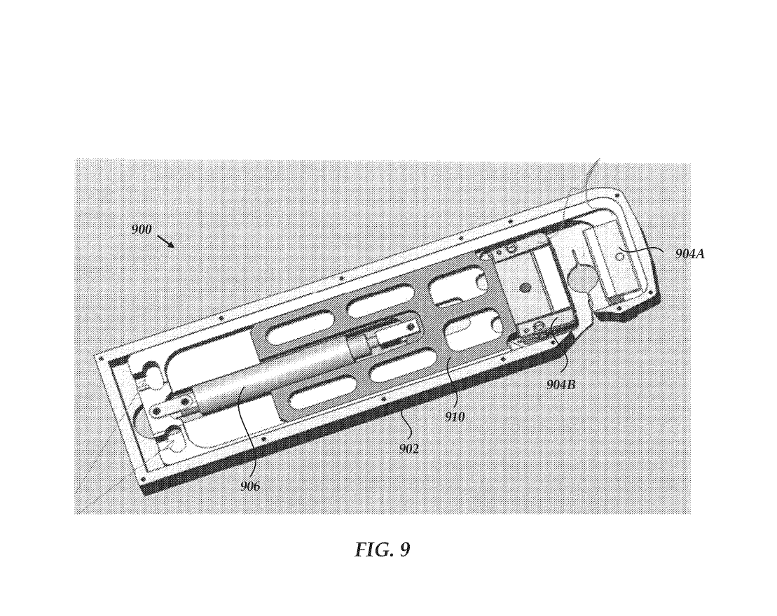

The spray drier device 102 also includes a plurality of sealing mechanisms 900 for sealing the collection chamber 104C after spray drying operations are complete. One embodiment of a sealing mechanism 900 is illustrated in FIG. 9. The sealing mechanism 900 may include a frame 902 and a pair of jaws 904A, 904B.

The upper and lower jaws 904A and 904B may be moveable with respect to the frame 900 and in concert with respect each other. They move a similar distance in opposite directions in a coupled motion such that when activated they advance toward one another to make the seal and when deactivated they retract apart. For example, a linear actuator 906 is in communication with a slide arm 910 abutting the lower jaw 904B. The linear actuator 906 may urge the slide arm 910 towards the upper jaw 904A, which in turn urges the lower jaw 904B towards the upper jaw 904A (e.g., into an engaged position). The linear actuator 906 may also move the opposite direction, urging the slide arm 910 away from the upper jaw 904A, which in turn urges the lower jaw 904B away from the upper jaw 904A (e.g., into a disengaged position).

The upper and lower jaws 904A, 904B may be further configured to hermetically seal and cut the collection chamber 104C. In one embodiment, the opposing surfaces of the jaws 904A, 904B may be heated. By placing a selected region of the collection chamber 104C (e.g., an inlet port such as 212A or exhaust port such as 212B) between the jaws 904A, 904B and compressing the jaws 904A, 904B together, opposing surfaces of the collection chamber 104C may be fused together, forming a hermetic seal. With sufficient pressure and heat applied to the selected region of the collection chamber 104C by the jaws 904A, 904B, this region may also be cut. Beneficially, by incorporating sealing mechanisms 900 into the spray drier device 102, the device 102 may cut and seal the collection chamber 104C from the spray drier assembly 104 while maintaining the sterile integrity of the assembly 104.

The process of sealing and cutting using the sealing mechanisms 900 may also be automated and controlled by the spray drier device 102. This automation may provide benefits including repeatability and reliability of the seals, reducing the possibility o of contaminants entering the collection chamber 104C during the sealing and cutting process. For example, automation may ensure that the collection chamber 104 is sealed and then cut, rather than cut and sealed due to operator error.

The terms comprise, include, and/or plural forms of each are open ended and include the listed parts and can include additional parts that are not listed. And/or is open ended and includes one or more of the listed parts and combinations of the listed parts.

One skilled in the art will realize the technology may be embodied in other specific forms without departing from the spirit or essential characteristics thereof. The foregoing embodiments are therefore to be considered in all respects illustrative rather than limiting of the technology described herein. Scope of the technology is thus indicated by the appended claims, rather than by the foregoing description, and all changes that come within the meaning and range of equivalency of the claims are therefore intended to be embraced therein.

What is claimed is:

1. A spray drier device, comprising:
a liquid sample port for receiving a flow of a liquid sample; and
a spray drier device dock adapted to couple with a spray drier assembly positioned within the dock, the dock including:
an aerosolizing gas port for receiving a flow of an aerosolizing gas;
a dryer gas port for receiving a flow of a drying gas;
wherein the aerosolizing gas port is not co-axial with the dryer gas port.

2. The spray drier device of claim 1, further comprising:
a locking mechanism positioned adjacent to the dock and configured to couple with a spray drier assembly positioned within the dock; and
an actuator configured to move the locking mechanism between an engaged and a disengaged position, wherein the locking mechanism inhibits removal of the spray drier assembly from the dock in the engaged position and wherein the locking mechanism does not inhibit removal of the spray drier assembly from the dock in the disengaged position.

3. The spray drier device of claim 2, the spray drier assembly further comprising:
a spray drying head attachable to the aerosolizing gas port and the dryer gas port for receiving the flow of aerosolizing gas and the drying gas, the spray drying head further configured to receive the flow of liquid sample, provide an aerosolized flow of liquid sample, and expose the aerosolized flow of liquid sample to the flow of drying gas; and
a drying chamber configured to receive the aerosolized flow of liquid sample and the flow of drying gas at a first end, separate the aerosolized flow of liquid sample and the flow of drying gas into a dried powder suspended in humid air, and output the suspended dried powder and humid air at a second end.

4. The spray drier device of claim 1, wherein the dock further comprises the liquid sample port.

5. The spray drier device of claim 3, wherein the spray drying head comprises the liquid sample port.

6. The spray drier device of claim 3, further comprising a collection chamber having a first end and a second end, wherein the first end of the collection chamber is in fluid communication with the second end of the drying chamber, and wherein the collection chamber is configured to separate the dried powder from humid air.

7. The spray drier device of claim 6, wherein at least a portion of the humid air separated from the dried powder is exhausted from the collection chamber at the second end of the collection chamber.

8. The spray drier device of claim 6, further comprising
a first one-way valve positioned at about the second end of the collection chamber, the first one-way valve permitting one way flow of the humid air from the collection chamber to the device and inhibiting flow of surrounding air back into the collection chamber; and
a second one-way valve positioned at about the second end of the drying chamber, the second one-way valve permitting flow of the dried powder and humid air from the drying chamber to the collection chamber and inhibiting flow of the dried powder and humid air from the collection chamber to the drying chamber.

9. The spray drier device of claim 6, wherein the collection chamber further includes a vessel containing a rehydration solution and a breakable seal, wherein the seal inhibits fluid communication between the rehydration solution and the dried plasma in an intact state and wherein the seal allows fluid communication between the rehydration solution and the dried plasma in a broken state.

10. The spray drier device of claim 3, wherein the spray drying head and the drying chamber are formed from a re-sterilizable material is selected from the group consisting of metals, metal alloys, stainless steels, and polymers.

11. The spray drier device of claim 6, further comprising an air expressing device configured to remove at least a portion of the humid air from the collection chamber, wherein the air expressing device comprises at least two plates disposed at opposing sides of the collection chamber, the at least two plates configured to move between a first position and a second position, wherein the at least two plates do not exert a compressive force upon the collection chamber in the first position and wherein the at least two plates exert a compressive force upon the collection chamber urging at least a portion of the humid air from the collection chamber.

12. The spray drier device of claim 6, further comprising an air expressing device configured to remove at least a portion of the humid air from the collection chamber, wherein the air expressing device comprises a vacuum pump in communication with the second end of the collection chamber or with the dryer gas port.

13. The spray drier device of claim 6, wherein at least one of the flow of drying gas and humid air is adapted to urge the dried powder from the drying chamber to the collection chamber.

14. The spray drier device of claim 3, wherein the spray drying head further includes a drying gas inlet for receiving the flow of drying gas, wherein the drying gas inlet includes an outwardly extending flange.

15. The spray drier device of claim 14, wherein the locking mechanism engages the flange when the spray drying head is positioned within the dock and the locking mechanism is in the engaged position.

16. The spray drier device of claim 15, wherein the locking mechanism comprises a plurality of cams or clamps.

17. The spray drier device of claim 1, wherein the liquid sample is received from a pooled source of liquid sample.

18. The spray drier device of claim 1, wherein the flow of drying gas is received from ambient environment via an ambient air inlet in fluid communication with the dryer gas port, the ambient air inlet including one or more ambient air filters.

19. The spray drier device of claim 18, wherein the ambient air filter has a combined bacterial filtration efficiency (BFE) of about 10⁶ or better.

20. The spray drier device of claim 6, wherein the flow of dryer gas is received from the humid air exhausted from the collection chamber.

21. The spray drier device of claim 1, wherein the dried powder has a mean particle size of less than or equal to 25 μm.

22. The spray drier device of claim 1, further comprising a fan coupled with at least one environmental chamber air filter, wherein the fan and environmental chamber air filter are configured to produce an air flow across the dock and spray drier assembly positioned within the dock that is sufficient to provide at least 200 CFU/m³ or less of bacteria in an environment within the housing adjacent to the dock and spray drier assembly.

23. The spray drier device of claim 6, further comprising a spray drier assembly cover including:
a first assembly cover member mounted to the spray drier device;
a second assembly cover member hinged to the first cover member and configured to move between an open position and a closed position;
wherein, in the closed position of the second cover member, the first and second assembly cover members contain the spray dryer assembly and inhibit deformation of the drying chamber and collection chamber when subjected to internal pressure; and
a plurality of guide features positioned on at least one of the first assembly cover member and the second assembly cover member, the plurality of guide features adapted to register and position the spray drier assembly within the spray drier assembly cover.

24. The spray drier device of claim 3, further comprising:
a plurality of port covers for covering the aerosolizing gas port and the dryer gas port; and
one or more sensors in communication with the plurality of port covers and in communication with the actuator and adapted to detect the presence or absence of the plurality of port covers;
wherein the actuator is adapted to engage when the one or more sensors detects the cover is present and wherein the actuator is adapted to not engage when the cover is absent and the spray drier assembly is not present in the dock.
